(19) United States
(12) Patent Application Publication
(10) Pub. No.: US 2013/0238987 A1
(43) Pub. Date: Sep. 12, 2013

(54) Patent Prosecution Tool

(71) Applicant: Mark Ian Lutwyche, Reisterstown, MD (US)

(72) Inventor: Mark Ian Lutwyche, Reisterstown, MD (US)

(21) Appl. No.: 13/790,055

(22) Filed: Mar. 8, 2013

Related U.S. Application Data
(60) Provisional application No. 61/609,345, filed on Mar. 11, 2012.

(51) Int. Cl. G06F 17/24

(52) U.S. Cl. CPC G06F 17/24
USPC 715/256

(57) ABSTRACT

Apparatus for editing patent claims including a user interface, a claim editor unit, and a claim display unit. The user interface receiving input of first editing instructions for editing words of patent claims. The claim editor unit editing the words of the patent claims based on the first editing instructions to form words of amended patent claims. The claim display unit adapted to convert the words of the patent claims to form text for amended patent claims. The claim editor unit including a claim editor logic unit that transforms at least one instruction of the first editing instructions to form second editing instructions. The claim editor logic unit forms the second editing instructions in compliance with editing requirements of a patent office. The claim editor logic unit applies the second editing instructions to the current state of the words of the amended patent claims.

### CROSS REFERENCE TO RELATED APPLICATIONS

This application claims priority to U.S. provisional application 61/609,345, filed Mar. 11, 2012, which is hereby incorporated by reference in its entirety.

### BACKGROUND

1. Technical Field

The present teaching relates to methods, systems, and programming for patent prosecution.

Particularly, the present teaching is directed to methods, systems, and programming for streamlining the patent prosecution process.

2. Discussion of Technical Background

Patent drafting and prosecution is a time consuming and expensive business. Many accurate documents must be produced and filed at a Patent Office. Often the documents have tight deadlines. Much of the document preparation is done by hand because of the complexity and variety of the tasks to be performed. As a result of the preparation by hand, the time for preparation can become quite long and many errors may be introduced. The above causes patent prosecution to be expensive due to the hourly cost of prosecution agents or attorneys, and well as additional costs in time and fees correcting the errors. Many errors go unnoticed throughout prosecution, causing additional costs for correction in reissue after the patent is granted. Such errors also cause inventors to lose granted patents or claim scope during litigation and licensing. Thus, means to reduce prosecution costs and error are of great value.

### SUMMARY

The teachings disclosed herein relate to methods, systems, and programming for patent prosecution. More particularly, the present teaching relates to methods, systems, and programming for streamlining the patent prosecution process.

In one embodiment, a method for editing patent claims performed by a machine including at least one processor is disclosed. The method comprising, receiving from a user, by the machine, first editing instructions for editing words of patent claims. The method further comprising, editing, by the machine, the words of the patent claims based on the first editing instructions to form words of amended patent claims. The method further comprising, processing, by the machine, the words of the amended patent claims to form text for amended patent claims. At least one instruction of the first editing instructions is transformed, by the machine, to form one or more second editing instructions. The one or more second editing instructions in compliance with editing requirements of a patent office. The one or more second editing instructions based on a current state of the words of the amended patent claims. The one or more second editing instructions are applied to the current state of the words of the amended patent claims.

In another embodiment, a tangible non-transient computer readable medium comprising a set of instructions that causes a machine to perform a method for editing patent claims. The method comprising the step of receiving, by the machine, text corresponding to patent claims. The method further comprising the step of separating, by the machine, the text into words of the patent claims. The method further comprising the step of receiving from a user, by the machine, first editing instructions for editing the words of the patent claims. The method comprising the step of editing, by the machine, the words and the patent claims based on the editing instructions to form words of amended patent claims. The method comprising the step of processing, by the machine, the words of the amended patent claims to form text for amended patent claims. At least one instruction of the first editing instruction is transformed, by the machine, to form one or more second editing instructions, the one or more second editing instructions in compliance with the editing requirements of a patent office. The one or more second editing instructions based on a current state of the words of the amended patent claims. The one or more second editing instructions are applied to the current state of the words of the amended patent claims.

In yet another embodiment, an apparatus for editing patent claims comprising a user interface, a claim editor unit, and a claim display unit. The user interface adapted to receive input of first editing instructions for editing words of patent claims. The claim editor unit adapted to edit the words of the patent claims based on the editing instructions to form words of amended patent claims. The claim display unit adapted to convert the words of the patent claims to form text for amended patent claims. The claim editor unit further comprising a claim editor logic unit adapted to transform at least one instruction of the first editing instructions to form one or more second editing instructions. The claim editor logic unit further adapted to form the one or more second editing instructions in compliance with editing requirements of a patent office and based on a current state of the words of the amended patent claims. The claim editor logic unit further adapted to apply the one or more second editing instructions to the current state of the words of the amended patent claims.

### BRIEF DESCRIPTION OF THE DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 depicts an exemplary claim from a patent in prosecution;

FIG. 2 depicts a patent prosecution preparation unit according to an embodiment;

FIG. 3 depicts a claim set analysis unit according to an embodiment;

FIG. 4A-F depict an exemplary output from the patent prosecution preparation unit according to an embodiment;

FIG. 5 depicts a claim checker unit according to an embodiment;

FIG. 6 depicts a claim editor unit according to an embodiment;

FIG. 7 depicts an exemplary portion of a rejection from a Patent Office according to an embodiment;

FIG. 8A-H depict a prosecution unit and exemplary output according to an embodiment;

FIG. 9A-C depict a method for editing patent claims according to an embodiment; and

FIG. 10 depicts a general computer architecture on which embodiments of the disclosure can be implemented according to an embodiment.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high level, without detail, in order to avoid unnecessarily obscuring aspects of the present teachings.

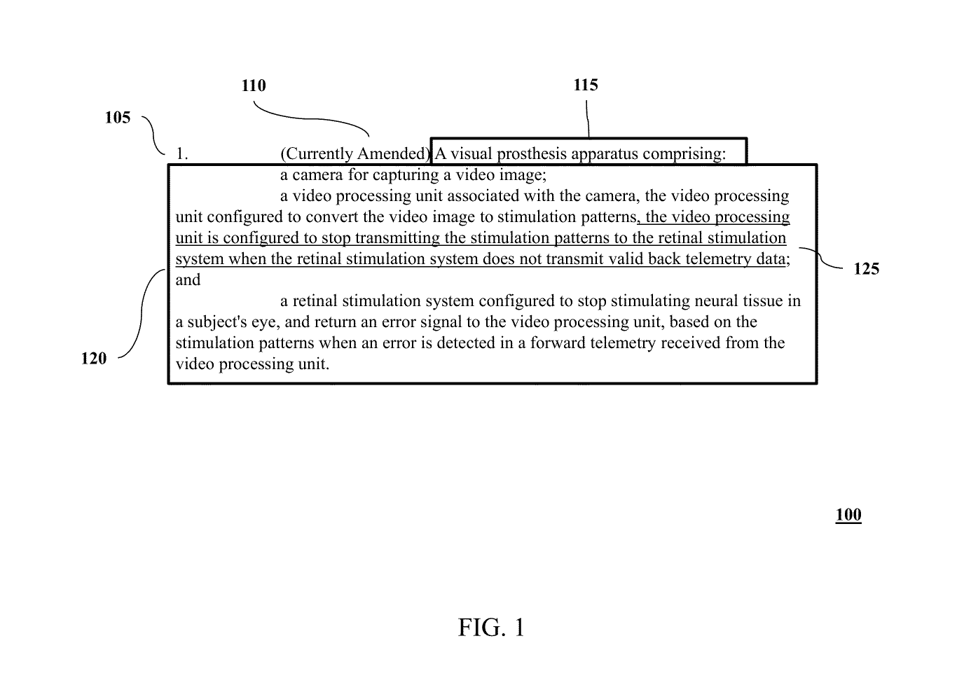

FIG. 1 depicts a claim from a patent in prosecution 100 according to an embodiment. The claim from the patent in prosecution 100 comprises a claim number 105, a claim status identifier 110, a preamble 115, a body 120, and an amendment 125.

The claim shown in the FIG. 1 corresponds to claim 1 from issued U.S. Pat. No. 8,000,000 that issued on Aug. 16, 2011. Claim 1 is shown at a point during prosecution. The claim was rejected by the Examiner, accordingly, the applicant amended claim with the amendment 125. The amendment 125 is shown underlined to indicate to the Patent Office that this text is new. The underlining of an amendment is a requirement by the Patent Office to make clear that the text is new. The claim number 105 indicates the number of the claim. Thus, this is the first claim in a set of claims. The claim status identifier 110 in Claim 1 is indicated as “(Currently Amended)”. The claim status identifier 110 is used to indicate to the Patent Office which claims are amended. If the claim has not been amended during prosecution, the claim status identifier 110 will be “(Original)”. If the claim has been amended during prosecution, but is not currently being amended, the claim status identifier 110 will be “(Previously Presented)”. A claim added during prosecution will have a claim status identifier “(New)” when first entered into the set of claims. Other claim status identifiers include “(Canceled)” for a claim that has been canceled during prosecution, and “(Withdrawn)” for a claim that has been withdrawn due to a restriction by the patent Examiner. Thus, when amending claims an applicant for a patent has to amend claims in compliance with the Patent Office requirements. Failure to amend the claims in compliance with the requirements may result in a rejection of the patent claims or an indication of a noncompliant amendment.

The applicant is thus faced with the challenge of amending the claims in compliance with the Patent Office regulations. Applicants use word processing programs to perform this task. For example, the track changes feature in Microsoft Word™ is often used to amend the claims. The track changes feature automatically underlines added text. Further, the track changes feature in Microsoft Word™ also strikes through deleted text. The Patent Office requires any text being removed in a claim amendment to be indicated as struck through. Thus, track changes in Microsoft Word™ is quite helpful when amending claims. However, track changes suffers from a number of drawbacks when amending patent claims because the US Patent Office has further requirements that Microsoft Word™ track changes does not perform automatically. The Patent Office requires that when text is deleted, whole words must be deleted. Thus, for example, if “ed” is to be removed from the end of a word, the Patent Office requires that the entire word be struck through and the word rewritten without the “ed”. Therefore, to change “added” to “add” would require the text, “added add”. A further requirement is that if fewer than four characters are deleted, the text to be deleted should be placed in double brackets. Thus, to delete “the” the text in the amended claim should be “[[the]]”. A further complication is that once a claim is amended, the claim status identifier 110 has to be changed without tracking the change to the claim status. Thus, when amending claims with track changes, the applicant must continuously switch the track changes feature on and off as different kinds of amendments are made. When placing text in square brackets, or changing the claim status identifier 110, track changes is switched off, and when changing other text track changes is switched on. The further complication is that formatting characters are not required to be tracked. Formatting characters include carriage returns, tabs and spaces. Thus, when changing the formatting of the claim to add carriage returns and tabs the track changes feature in Microsoft Word™ should be switched off.

When adding a new claim, none of the text needs to be underlined because a claim status identifier of “(New)” at the beginning of the claim indicates that all of the text in the new claim is added. Thus, when editing a new claim, the track changes feature in Microsoft Word™ should be switched off.

This requirement to constantly switch the track changes feature on and off in Microsoft Word™ or similar word processing programs may cause errors to be made by the applicant. The applicant may inadvertently add text without underlining or delete text without indicating the deletion by strikethrough or double brackets. Further, it is common to forget to change the claim status identifier for amended claims. In particular, the applicant may amend the claim and change the claim status identifier to “(Currently Amended)”. Subsequently, the applicant may decide that the claim amendment was unnecessary and remove the amendment. The applicant, however, may forget to change the claim status identifier back to its state before the amendment.

A further issue occurs when canceling or withdrawing claims. When a claim is canceled, the text of the claim should be removed as well as changing the claim status identifier to “(Canceled)”. It is easy to forget to remove all of the text from that claim. In US patent claims, a claim can be dependent on another claim. For example, claim 2 in U.S. Pat. No. 8,000,000 discussed above, begins, “The visual prosthesis apparatus of claim 1, wherein . . . ”. If claim 1 is canceled or withdrawn, and claim 2 is not amended, claim 2 will improperly depend from canceled claim 1. A common mistake when amending claims is to cancel a claim and inadvertently forget to amend all of the dependent claims.

While amending the claims there are further difficulties for the applicant. The first of these difficulties is the claim grammar. The claim should begin with a capital letter and end with a period. Patent claims are usually divided into clause structures. The claim shown in FIG. 1, for example, has a comprising clause. The first line ends with “comprising:” each subsequent paragraph of the claim details the elements in the comprising clause. There are three elements listed, a camera, a video processing unit, and a retinal stimulation system. The three elements are separated by “;” the last two elements separated by “; and”. There are many such clause structures in patent claims, for example, “including:”, “consisting of:”, and “wherein:” among others. The “;” and “; and” language can be important for indicating where particular elements in the claim belong. This is because, for example, comprising clauses and other clauses can be nested. Thus, one of the elements in a comprising clause may have a nested including clause. The position of “;” and “; and” language may be the only manner by which a reader of the claim can determine whether an element is a part of the comprising clause or the including clause. A common error in drafting patent claims or amending patent claims is to forget the “and”, or to forget to move an “and” if an element is added to a clause.

Antecedence is another issue for the applicant to deal with. Features in patent claims are introduced with indefinite articles. Subsequently, definite articles are used for the same feature further along in the claim. In the claim of FIG. 1, “a camera” is introduced with an indefinite article in the second line. “the camera” in the third line indicates to the reader of the claim that “the camera” in the third line is the same camera as “a camera” in the second line. Maintaining proper antecedence in patent claims can become very burdensome. Dependent claims also have to maintain proper antecedence with features in the claims from which those claims depend. A common error is to introduce a feature in, for example, claim 1. Claims 2-9 that depend from claim 1 repeat the feature correctly using the definite article. Claim 10 is a new independent claim that does not reintroduce the feature with an indefinite article. Claims 11-18 that depend from claim 10, then inappropriately use the definite article when reciting the feature because the applicant refers to claims 1-9, when drafting or amending claims 11-18.

Another common antecedence error is to use wording that is slightly different to refer to the same feature. For example, a claim may begin with “a virus checking unit” but subsequently discuss “the virus checker unit”. Such subtle inconsistencies can be very difficult to detect but may cause considerable expense and difficulty later in prosecution or litigation.

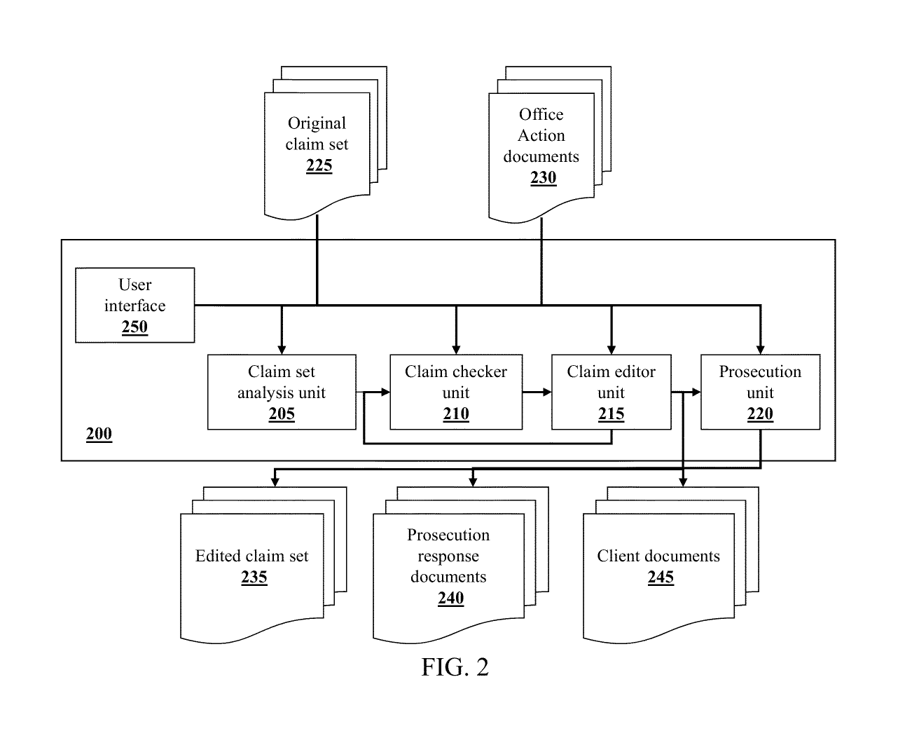

FIG. 2 depicts a patent prosecution preparation unit 200 according to an embodiment. The patent prosecution preparation unit 200 comprises a claim set analysis unit 205, a claim checker unit 210, a claim editor unit 215, a prosecution unit 220, and a user interface 250. The patent prosecution preparation unit 200 processes an original claim set 225 and Office Action documents 230, to produce an edited claim set 235, prosecution response documents 240, and client documents 245.

The original claim set 225 corresponds to the claims as the claims were before the current Office Action. The edited claim set 235 corresponds to the claims after editing or amendment. The Office Action documents 230 correspond to a Rejection, Final Rejection, Advisory Action, etc., and any alleged prior art references. The prosecution response documents 240 correspond to an Amendment, Request for Reconsideration, Pre-Appeal Brief Request for Review, Appeal, etc. as well as any supporting documents such as declarations and evidence. The client documents 245 correspond to letters generated by the applicant's representative for communicating with an applicant. The client documents 245 detail what is being done with respect to the current stage in prosecution.

The patent prosecution preparation unit 200 enables an applicant for patent to prepare rapidly claim amendments and Responses to Office Actions issued by a patent office. The patent prosecution preparation unit 200 allows the applicant to amend the claims, if necessary, in a manner acceptable in particular to the U.S. Patent and Trademark Office, and prevents the applicant from accidentally deleting or adding text to the claims without indicating the text deleted or added. The patent prosecution preparation unit 200 also automatically updates status identifiers of the claims in accordance with the claim amendments made by the applicant. The patent prosecution preparation unit 200 further checks the claims for grammar errors, antecedence errors, and claim dependence errors. The patent prosecution preparation unit 200 further allows the applicant to input data corresponding to the informalities noted and rejections made by the Patent Office Examiner in the Office Action. Based on the data input by the applicant regarding the Office Action and an analysis of the amended claims, the patent prosecution preparation unit 200 constructs portions of the text for a Response to the Office Action. The patent prosecution preparation unit 200 inserts appropriate indicators for the applicant indicating where arguments should be placed to complete the Response to the Office Action. In the above manner, the patent prosecution preparation unit 200 saves considerable time for the applicant, and ensures that the Remarks section in the Response is consistent with the claim amendments and is fully responsive to the rejections in the Office Action. The claim set analysis unit 205, the claim checker unit 210, the claim editor unit 215, the prosecution unit 220, and the user interface 250 are all able to communicate with one another as required and are all capable of outputting information for the edited claim set 235, the prosecution response documents 240, and the client documents 245. The claim set analysis unit 205, the claim checker unit 210, the claim editor unit 215, the prosecution unit 220, the user interface 250, and the functions of those units are discussed in detail below.

The claim set analysis unit 205 analyzes the original claim set 225 input to the patent prosecution preparation unit 200. The claim set analysis unit 205 outputs the analyzed claims to the claim checker unit 210. The claim checker unit 210 checks the claims for dependence, antecedence, grammar, etc. and outputs the results to the claim editor unit 215. The claim editor unit 215 displays the claims along with the errors found, and allows the applicant to amend and edit the claims in conformance with the US Patent Office guidelines. As the claims are edited, the edited claims are checked by the claim checker unit 210 in real time so that the applicant can see errors in the claim set as the errors are added or removed by the amendments made. In some embodiments, the original claim set 225 is input as a text file by, for example, opening the text file from within the prosecution preparation unit 200 using the user interface 250. In some embodiments, the original claim set 225 is input by scanning a paper document file by, for example, scanning the document from within the prosecution preparation unit 200 using a menu or alternative user interface. In some embodiments, the original claim set 225 is input by opening an already edited claim set. The already edited claim set was generated by the prosecution preparation unit 200 in response to a previous Office Action. If the original claim set is input by opening already edited claim set, the prosecution preparation unit 200 accepts any edits remaining in the already edited claim set before allowing the claims to be further edited by the claim editor unit 215.

In some embodiments, the prosecution unit 220 takes input from the claim editor unit 215 in the form of the edited claim set 235 and the original claim set 225. In some embodiments, the prosecution unit 220 takes input from the claim editor unit 215 in the form of computer readable versions of the edited claim set 235 and the original claim set 225. The patent prosecution unit 220 also takes input from the Office Action documents 230, if any such documents exist. The Office Action documents 230 may include, for example, Rejections, Final Rejections, Advisory Actions, Office Actions indicating a noncompliant amendment, or any other correspondence from the Patent Office regarding the application. The prosecution unit 220 also takes input from the applicant, via the user interface 250, regarding how the applicant intends to argue with the Patent Office position and/or amend the claims. The prosecution unit 220 combines all of the above information to form portions of the prosecution response documents 240 such as Amendments, Requests for Reconsideration, Pre-Appeal Brief requests for Review, Appeals, etc. In some embodiments, the prosecution unit 220 also forms the client documents 245 as portions of letters for the clients based on the above information. If the applicant's representative is preparing the response the prosecution unit 220 allows the applicant's representative to communicate all of their arguments and changes to the applicant. Because the prosecution unit 220 produces both the portions of the response (the prosecution response documents 240) and the portions of the letters to the applicant (the client documents 245), the response to the Patent Office and letters to the applicant will convey consistent and complete information regarding the response. Thus, the applicant's representative does not have to independently construct two separate documents, one for the Patent Office and one for the applicant because the prosecution unit 220 produces large portions of both documents simultaneously under the direction of the applicant's representative. Further, the prosecution unit 220 limits the way that the applicant's representative can respond to an Office Action by preventing the applicant or applicant's representative from amending the claims in a manner that is not acceptable to the Patent Office, and from making arguments that are not likely to be successful. For example, if two references are used in a §102 rejection with one of the references being used merely for evidence, the prosecution unit 220 does not allow the applicant to select an argument asserting that the references are not combinable because that argument will likely not be successful.

The user interface 250 allows a user to input directions to any portion of the prosecution preparation unit 200 as required. For input of data, instructions, or directions by a user, the user interface 250 includes one or more of keyboards, mouse, touch pad, touch screen, track ball, sound, speech, cameras, image scanners or any other form of input device know or to be developed in the future. For output of data, instructions, or directions to a user, the user interface 250 includes one or more of display screens, sound and vibration output, lights and indicators, printers or any other form of output device known or to be developed in the future. In some embodiments, the input or output devices are connected to the prosecution preparation unit 200 by wires. In some embodiments, the input or output devices are connected to the prosecution preparation unit 200 wirelessly. In some embodiments, the input or output devices are situated close to the prosecution preparation unit 200. In some embodiments, the input or output devices are situated far from the prosecution preparation unit 200. In some embodiments, the input or output devices are connected to the prosecution preparation unit 200 via a computer network. The computer network is any combination of wired networks or wireless networks. The computer networks include, for example, the Internet, mobile phone networks, or Piconet™ networks. In some embodiments, the user interface 250 is on the same machine as the prosecution preparation unit 200. In some embodiments, the user interface 250 is on a different machine to the prosecution preparation unit 200. In some embodiments, the prosecution preparation unit 200 is hosted on a server for example an Internet server and the user interface 250 is a portion of a separate device in communication with the server. The separate device may be, for example, a cell phone, a laptop computer, a desktop computer, a tablet computer, an e-reader or any other device capable of communicating with the server.

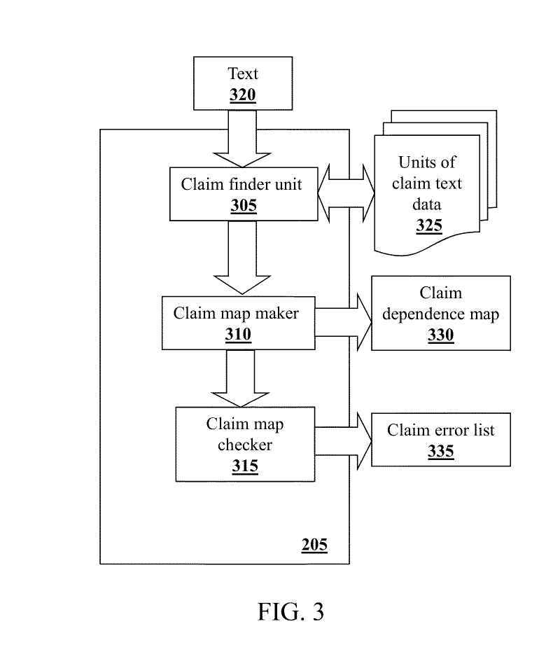

FIG. 3 depicts a claim set analysis unit 205 according to an embodiment. The claim set analysis unit 205 comprises a claim finder unit 305, a claim map maker 310, and a claim map checker 315. The claim set analysis unit 205 takes as an input a text 320, or units of claim text data 325 previously stored by the claim set analysis unit 205. The claim set analysis unit 205 outputs units of claim text data 325, a claim dependence map 330, and a claim error list 335.

The units of claim text data 325 comprise lists of words for each claim including the claim status identifier 110 and the claim number 105. Each word in the lists of words has associated attributes, for example, the type of word, verb, indefinite article, definite article, etc. Each word also has attributes indicating whether the word is added, deleted, has been presented to the Patent Office, etc. In some embodiments of this application, format characters like TAB and CR are considered to be words. Further, in some embodiments of this application, punctuation marks are also considered to be words. In some embodiments, the format characters and punctuation marks also have the above associated attributes.

The claim set analysis unit 205 analyzes a set of claims input into the claim set analysis unit 205. In some embodiments, the set of claims is input by copying the claims from a document using copy and paste features of an operating system. The text 320 copied into the clipboard of the operating system is then pasted into the claim set analysis unit 205. In some embodiments, the claims analysis unit is capable of opening a text file, for example, a Microsoft Word™ document, an RTF file, etc. and copying the text 320 from the file for analysis. The claim set analysis unit 205 is also capable of saving and reopening units of claim text data 325 that the claim set analysis unit 205 generated. In some embodiments, the actions of the claim set analysis unit 205 are directed by a user via a user interface, for example, user interface 250. The claim finder unit 305 finds the claims in the text 320 and the words in those claims. In some embodiments, format characters like TAB and CR are considered to be words. Further, in some embodiments, punctuation marks are also considered to be words. During the process of finding the claims and the words in the claims, the claim finder unit 305 also checks each word in the text 320 to see if the word is struck through or underlined (by, for example, track changes in Microsoft Word™ or by using font attributes or, for example, RTF commands). The claim finder unit 305 marks those words accordingly as being added or deleted in the units of claim text data 325 being generated. The claim finder unit 305 also checks for portions of text in double brackets. These portions of text are also marked as deleted in the units of claim text data 325 being generated. If the claim finder unit 305 finds words that are partially underlined or partially struck through, the claim finder unit 305 enters two versions of the word into the corresponding units claim of text data 325. The first version of the word corresponds to the word before the alteration was made. The second version of the word corresponds to the word after the alteration is made. Thus, for example, “themselves” will become “themselves the” and “themselves” will become “the themselves”. The claim finder unit 305 also notes that the word was not edited in conformance with U.S. practice and marks the word with an error so that the applicant or the applicant's representative can check the amendment against the original claim set 225 to see if the claim finder unit 305 has interpreted the amendment correctly.

The claim finder unit 305 also employs a claim status checker described below to check for amendments in each claim and compare with the claim status identifier. For example, if some of the claims have claim status identifiers and some of the claims do not have claim status identifiers, the claim finder unit 305 indicates to the applicant or the applicant's representative that the claim set is inconsistent. In this case, the claim finder unit 305 requests the applicant to indicate if claim status identifiers should be added to the claims that do not have claim status identifiers and asks the applicant for the correct claim status identifier for each claim. Further, the claim finder unit 305 notes if the text 320 of a claim is amended by strikethrough, underline, or double brackets. If the claim finder unit 305 notes that the text 320 of the claim is amended, but that the claim status identifier 110 is not “(Currently Amended)”, or “(Withdrawn—Currently Amended)” the claim finder unit 305 questions the applicant regarding whether the claim status identifier 110 should be changed to indicate that the claim is amended or whether the amendments in the claims should be accepted. To accept the amendments in the claims, if requested, the claim finder unit 305 converts underlined words to non-underlined words and removes strikethrough or double bracketed words. The claim status identifier 110 is then left unchanged.

The above checks by the claim finder unit 305 allow partially amended claim sets to be imported into the patent prosecution preparation unit 200. This may occur, for example, if the applicant has attempted to amend the claims and sends the partially amended claims set to the applicant's representative. The applicant's representative can then import the partially amended claims into the patent prosecution preparation unit 200, knowing that at least some of the informalities and mistakes introduced by the applicant will be caught and flagged by the patent prosecution preparation unit 200 during entry.

If the claim finder unit 305 discovers that the claim status identifiers are in accordance with the amendments, the claim finder may ask the applicant or the applicant's representative if the claim amendments should be accepted and the claim status identifiers updated. This is useful because the applicant or the applicant's representative may be inputting a copy of the claims from the previous amendment. Thus, the first thing to do is accept all the amendments from that previous amendment before proceeding to amend the claims further. If requested to do so, the claim finder unit 305 accepts all of the amendments by converting underlined text to plain text, removing struck through text and text in double brackets, and converting “(Currently Amended)” claim status identifiers to “(Previously Presented)” claim status identifiers, “(Canceled)” claim status identifiers to “(Previously Canceled)” claim status identifiers, “(Withdrawn)” claim status identifiers to “(Previously Withdrawn)” claim status identifiers, and “(New)” claim status identifiers to “(Previously Presented)” claim status identifiers.

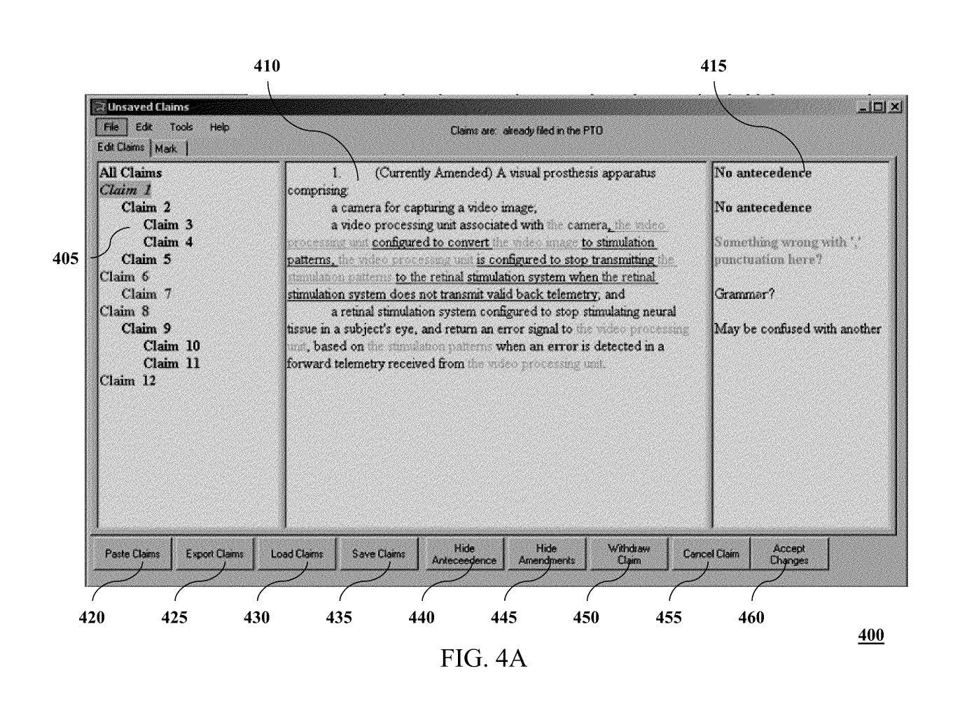

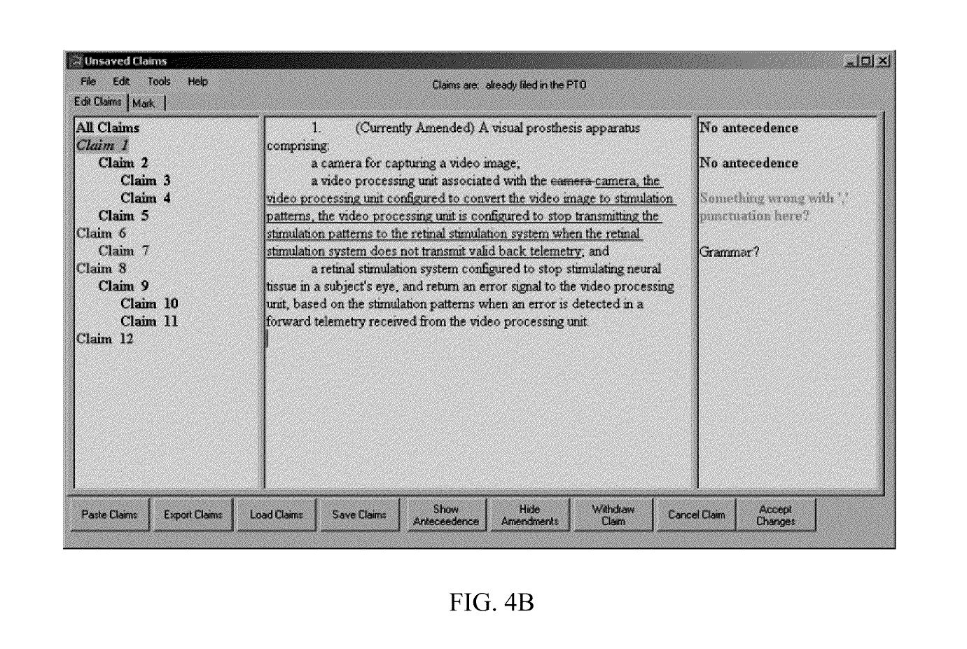

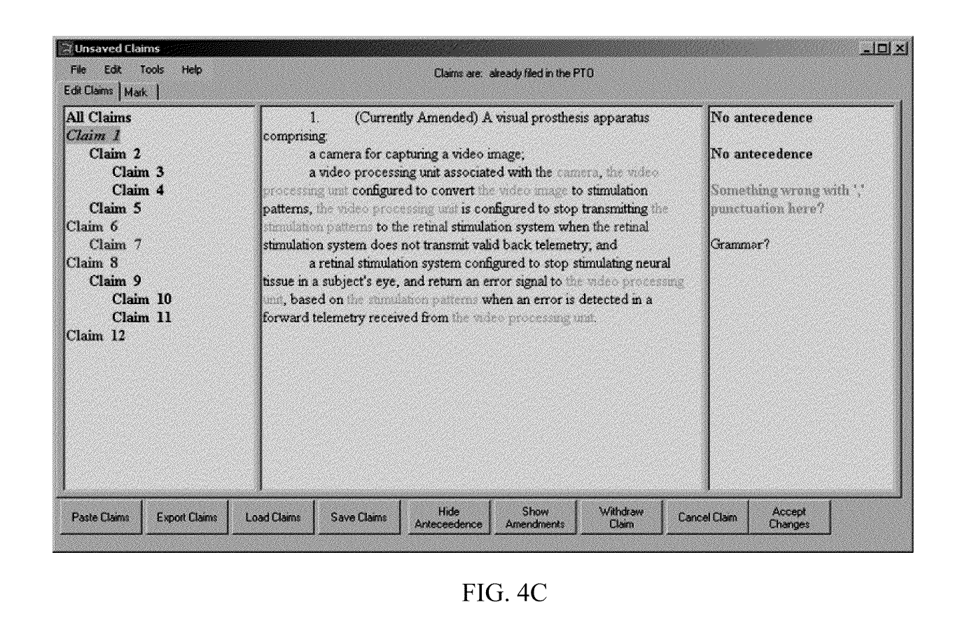

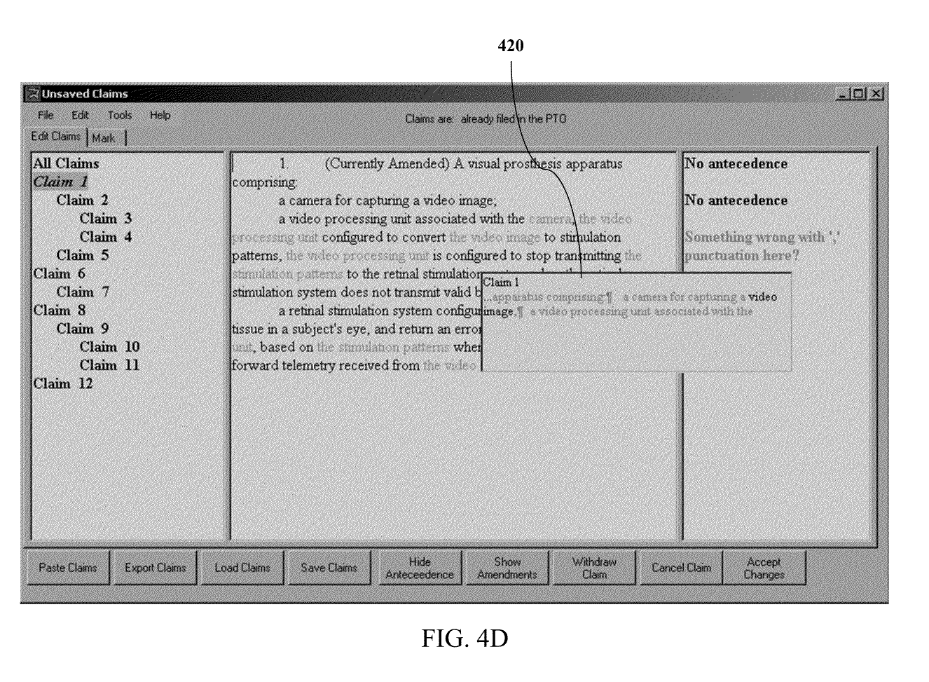

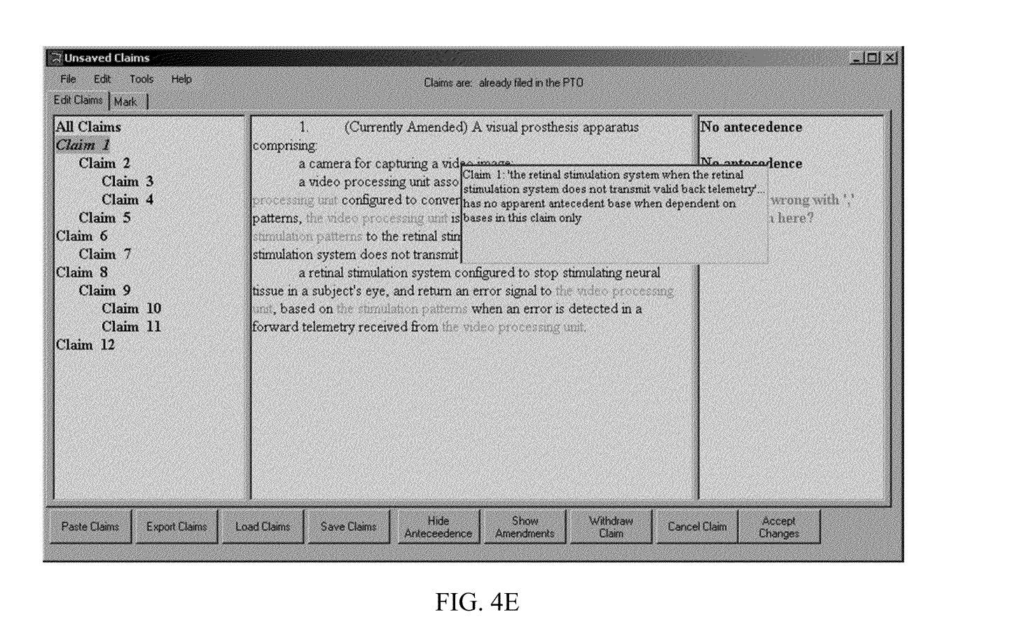

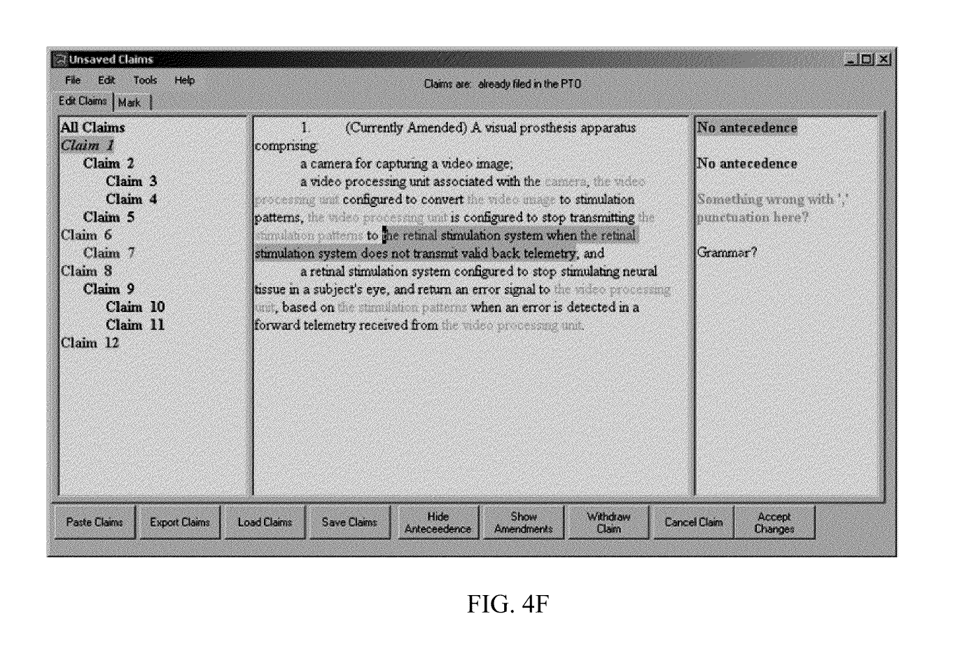

If no claim status identifiers are found, the claim finder unit 305 will ask the applicant or applicant's representative if the claims have been filed in the patent office. If the applicant's representative indicates that the claims have not been filed in the patent office, then in some embodiments, claim finder unit 305 gives each claim, a claim status identifier of “(None)”. If the absence representative indicates that the claims have been filed in the patent office, the claim finder unit 305 assumes that no office action has been responded to at this point, and no amendments have been made. The claim finder unit 305, therefore, gives each claim a claim status identifier of “(Original).” In some embodiments, if the claim finder unit 305 finds no claim status identifiers, the claim finder unit 305 asks the applicant's representative if the claims are not filed in the patent office, or are already patented. If the applicant's representative indicates that the claims are not filed, the claim finder unit 305 gives each claim a claim status identifier of “(Not Filed)”. If the applicant's representative indicates that the claims are patented, the claim finder unit 305 gives each claim a claim status identifier of “(Patented)”. The claim map maker 310 takes the information regarding each claim dependence found by a claim dependence finder, discussed below, and forms a claim dependence map 330 showing the claim dependence. The claim dependence map 330 indicates which claims depend from which other claims. FIG. 4 illustrates output from the patent prosecution preparation unit 200. In particular, the claim map box 405 shows the claim map for the 8,000,000 patent claims. Claims that are indented in the claim map box 405 are dependent from the preceding claim that is indented less. Thus, claims 2 and 5 indented once depend from claim 1, and claims 3 and 4 indented twice depend from claim 2.

The claim map maker 310 unit also accounts for multiple dependent claims. In the claim dependence map 330, multiple dependent claims that depend from more than one claim are duplicated. Thus, if claim 4 depends from claim 1 or claim 2, then in the claim map claim 4 will be repeated indented under claim 1, and again indented under claim 2.

The claim map checker 315 checks the claim dependence map 330 for errors. The errors include claims that depend on claims that are canceled or withdrawn. The errors further include multiple dependent claims that depend on multiple dependent claims. Under US practice, multiple dependent claims that depend on multiple dependent claims are not acceptable. The claim map checker 315 also checks for dependence loops, for example, claim 5, depending from claim 2, claim 7 depending from claim 5, and claim 2, depending from claim 7. Such loops can occur in particular, when dependent claims are rewritten in independent form, or when claims are amended to depend from a different base claim. Any errors found by the time dependence checker are logged in the claim error list 335.

As noted above, FIG. 4A depicts an exemplary output from the patent prosecution preparation unit 400 according to an embodiment. The exemplary output from the patent prosecution preparation unit 400 comprises a claim map box 405, a claim text box 410, an error text box 415, a paste claim button 420, an export claims button 425, a load claims button 430, a save claims button 435, a hide antecedence button 440, a hide claim amendments button 445, a withdraw claim button 450, a cancel claim button 455, and an accept changes button 460.

The claim map box 405 displays a map of the claims in the claim set based on the claim dependence map 330. Each claim is listed in the map box as a label with the word “claim” followed by the claim number, for example, “claim 10.” The claim labels are listed in ascending order, unless claim dependence overrides the ascending order. Claims that depend from a base claim are listed under the base claim and indented to indicate that they depend from the above claim. The claim map box 405 further indicates the status of the claims by the manner in which the labels for claims are displayed. If a claim is amended or added, for example, the label for the claim may be in italics. If the claim is canceled, the label for the claim may be struck through. If the claim is withdrawn, the label for the claim may be grayed. Thus, at a glance the applicant or applicant's representative can see the status of each claim. Claims that have errors may be indicated by different colors for the claim labels. For example, black or green may indicate claims that appear to have no errors. Red, orange, pink, or purple may be used for different grades of errors. For example, the most serious errors are red, warnings are orange, and advice is pink or purple. Thus, at a glance, the applicant or applicant's representative can see which claims likely need attention, and which claims may be in a reasonable state.

The claim map box 405 is interactive. Selecting on one of the claims in the claim map box 405 causes that claim to be displayed in the claim text box 410. The claim map box 405 also includes the label “All Claims”. Selecting the “All Claims” label causes all of the claims to be listed in the claim text box 410. As the claims are edited, canceled, withdrawn, or added the labels in the claim map box 405 are updated accordingly. If the claim status, claim dependence or claim errors change the claim dependence map 330 and the claim map in the claim map box 405 change accordingly.

The claim text box 410 displays a claim or set of claims depending on which is selected from the claim map box 405. The claim text box 410 allows the claims to be amended by placing a cursor into the text, and typing. Text may also be selected, copied, pasted, cut, or dragged in a similar manner to any word processor program, or text editor. However, as discussed below, the editing may not produce the same results as in a standard word processor, because a claim editor unit 215 described below intercepts the typing and depending on the current point in the prosecution process, transforms the editing commands to commands that adhere to patent office requirements. For example, the claim editor unit 215 forces added text to be underlined and deleted text to be struck through or placed in double brackets. In some embodiments, if a set of claims is displayed, the claim text box 410 does not allow editing, but only allows editing if a single claim is displayed in the claim text box 410.

In some embodiments, the text in the claim text box 410 is displayed with different colors. The colors can be switched on and off using the show antecedence button 440 and the hide claim amendments button 445. If the hide claim amendments button 445 is switched on, the claim amendments are shown as underlined text, strikethrough text or double-bracketed text. If the hide claim amendments button 445 is switched off the claim amendments are not marked in the above manner and deleted text is not displayed. This allows the applicant or applicant's representative to read the final claim without the distraction of the claim amendments being visible. In some embodiments, if the hide antecedence button 440 is switched off and the hide claim amendments button 445 is switched on the claim amendments may be shown in different colors. For example, deleted text may be shown in red and added text may be shown in blue.

If the hide antecedence button 440 is switched on, different colors are used to show the antecedence relationships of the claims, as shown in FIG. 4C. For example, in FIG. 4C antecedence bases (features, beginning with an indefinite article on no article) may be shown in blue. Features, beginning with a definite article may be shown in green. Features that have errors in antecedence may be shown in red. For example, in FIG. 4C the text “the retinal” may be shown in red. This is because “the retinal stimulation system” has not been introduced with an indefinite or no article. Therefore, the patent reader is unclear which retinal stimulation system is being discussed at this point in the claim. Interestingly, this antecedence error remains in the issued patent.

As well as indicating features that have not been properly introduced like the retinal stimulation system discussed above, features that are improperly re-introduced with an indefinite article on the article are indicated in red. Thus, if the claim began with “a car” and later in the claim, “a car” is re-recited the second “a car” would be displayed in red to indicate to the applicant or the applicant's representatives that there may be an issue with the feature. If the antecedence of a feature is unclear or confusing, then the feature may be displayed in, for example, orange or purple. An example of an unclear feature includes introducing “a first car” and then reciting “the car”. If no second car has been introduced, then it is clear that “the car” refers to the first car. However, for clarity, it is probably better to amend “the car” to “the first car”. Therefore, “the car” may be in orange or purple. Many other such issues that are detected by the antecedence finder described later may be in different colors.

Rolling over text with antecedence brings a pop-up box 470 that gives more information regarding the antecedence, as shown in FIG. 4D. In FIG. 4D the position of the antecedent base and the claim of the antecedent base are shown in the pop-up box 470. The additional information may indicate the claim in which the antecedent base is to be found, the portion of the text surrounding the antecedent base, other places in the claims where the feature can be found, etc. In some embodiments, right clicking on a feature with a definite article changes the claim in the claim text box 410 in the position of the cursor to the position of the antecedence base.

In some embodiments, rolling over an antecedence based shows the positions of all of the features that rely on this antecedence base as well as inappropriate re-recitations of the base. In some embodiments, rolling over inappropriate re-recitations of the base shows the other occurrences of the base.

The error text box 415 displays errors detected in the claims. Different colors for the errors indicate, for example, a severity of an error. For example, red may indicate a very severe error, orange a warning, and pink or purple advice. The text in the error text box 415 is interactive. Rolling over the text of an error produces a more detailed description of the error, as shown in FIG. 4E. Selecting an error causes the error to be highlighted and causes the position of the error to be highlighted in the claim text box 410 as shown in FIG. 4F. When highlighting the position of an error in the claim text box 410, the claim text box 410 is automatically scrolled to the appropriate position.

In some embodiments, if all of the claims are displayed in the claim text box 410, all of the errors are displayed in the error text box 415. In some embodiments, if only one of the claims is displayed in the claim text box 410 only errors corresponding to that claim are displayed in the error text box 415.

The paste claims button 420 allows text copied to the clipboard of the host computer to be input to the patent prosecution preparation unit 200. The applicant selects a different program, for example, Microsoft Word™, selects the text 320 corresponding to the claims, and copies the text 320 to the clipboard. Returning to the patent prosecution preparation unit 200, the applicant presses the paste claims button 420 to enter the text 320 into the patent prosecution preparation unit 200.

The export claims button 425 allows the claim set to be exported back to for example Microsoft Word™. When the export claims button 425 is selected, the edited claim set 235 is copied to the clipboard. The export process removes all coloration in the text regarding antecedence marking and amendments. In some embodiments, the exported text uses strikethrough, underline, and double brackets to indicate amendments in the exported claim set. In some embodiments, the exported text uses, for example, the track changes feature in Microsoft Word™ to export the claim set amendments. If track changes is used to export the claim amendments, then the double bracket feature cannot be used. In this case, the export function changes, deletions made using double brackets by deleting more than four characters using the track changes strikethrough feature, and re-adding additional characters corresponding to the characters that were additionally deleted. Thus, “[[the]] car” is converted to “the car car”. The export process also changes any nonstandard claim status identifiers to standard claim status identifiers. For example, a claim that was deleted in a previous Office Action is conveniently given a claim status identifier of “(Previously Canceled)” within the patent prosecution preparation unit 200. This enables the patent prosecution preparation unit 200 to identify correctly claims that should be listed as newly canceled in the current response. Claims with a status identifier of “(Previously Canceled)” do not need to be included on the list of newly canceled claims.

The claim status identifier “(Previously Canceled)” is substituted for canceled when the claims are entered using the claim finder unit 305. If a claim status identifier of “(Canceled)” is found, the claim finder unit 305 asks the applicant if the claim was previously canceled. If the claim was previously canceled, the claim finder unit 305 substitutes the claim status identifier “(Previously Canceled)”. A similar process is used for withdrawn claims so that previously withdrawn claims are not re-listed as being withdrawn in an Amendment.

The load claims button 430 allows a previously stored set of claims entered into the patent prosecution preparation unit 200, to be reloaded into the patent prosecution preparation unit 200.

The save claims button 435 allows a set of claims already in the patent prosecution preparation unit 200 to be stored as a file for later use.

The withdraw claim button 450, when selected, converts the current claim shown in the claim text box 410 into a withdrawn claim by changing the claim status identifier 110. If a withdrawn claim is shown in the claim text box 410, the withdraw claim button 450 allows that claim to be converted to a non-withdrawn claim. The patent prosecution preparation unit 200 will update the claim status identifier to the claim status identifier before the claim was withdrawn, if the patent prosecution preparation unit 200 has stored that claim status identifier. If the previous claim status identifier is not stored by the patent prosecution preparation unit 200, the patent prosecution preparation unit 200 asks the applicant or the applicant's representative for the previous claim status identifier and changes the claim status identifier accordingly.

The cancel claim button 455, when selected, converts the current claim shown in the claim text box 410 into a canceled claim by changing the claim status identifier 110. Further, in some embodiments, the text of the claim is removed as required by Patent Office guidelines. In some embodiments, the text is merely grayed and further editing prevented. This allows the applicant to read the text of the canceled claim, if needed. If the claim is exported out of the patent prosecution preparation unit 200, the grayed text is removed from the claim. If a canceled claim is shown in the claim text box 410, the cancel claim button 455 allows that claim to be converted to an un-canceled claim. The patent prosecution preparation unit 200 will update the claim status identifier to the claim status identifier before the claim was canceled, if the patent prosecution preparation unit 200 has stored that claim status identifier. If the previous claim status identifier is not stored by the patent prosecution preparation unit 200, the patent prosecution preparation unit 200 asks the applicant or the applicant's representative for the previous state of the claim status identifier before converting the claim status identifier. If the text of the claim is grayed or removed, the text is restored and editing is allowed.

The accept changes button 460, when selected, causes all amendments in the claims to be accepted by changing underlined text to normal text and removing struck through text and text in double brackets. The claim status identifiers 110 are also updated by converting “(Currently Amended)” claim status identifiers to “(Previously Presented)”, “(Canceled)” claim status identifiers to “(Previously Canceled)” claim status identifiers, “(Withdrawn)” claim status identifier to “(Previously Withdrawn)” claim status identifiers, and “(New)” claim status identifiers to “(Previously Presented)” claim status identifiers.

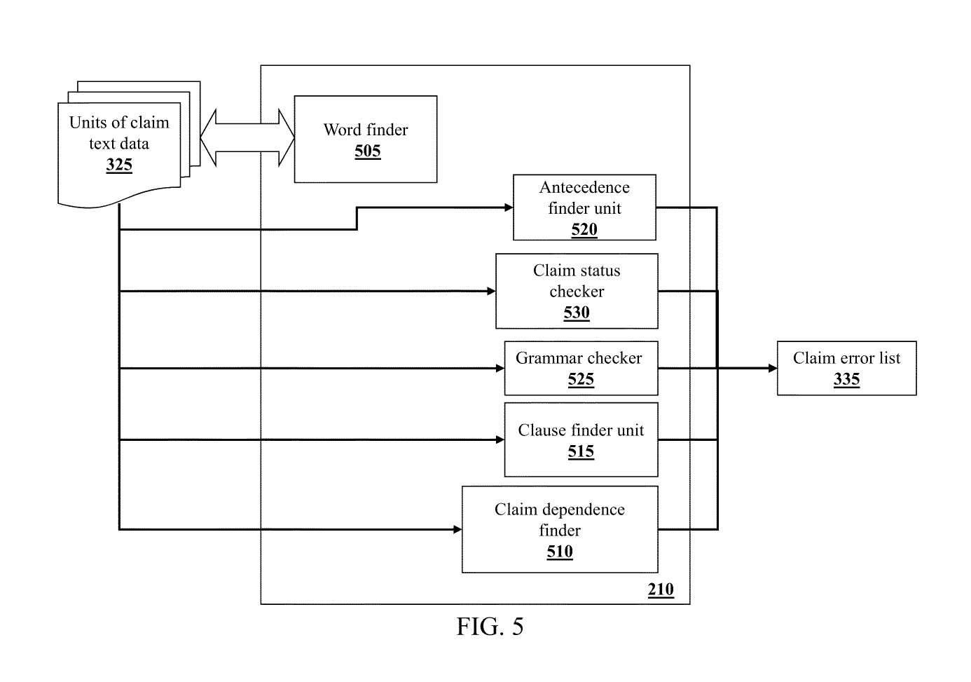

FIG. 5 depicts a claim checker unit 210 according to an embodiment. The claim checker unit 210 comprises a word finder 505, a claim dependence finder 510, a clause finder unit 515, an antecedence finder unit 520, a grammar checker 525, and a claim status checker 530.

The claim checker unit 210 provides functions for checking each claim for informalities and other errors. The claim dependence finder 510, the clause finder unit 515, the antecedence finder unit 520, the grammar checker 525, and the claim status checker 530 use the claim units of text data 325 as the source for checking the claims and outputting any errors found to the claim error list 335.

The word finder 505 is used to find words in the text 320 or in the units of claim text data 325 and classify the words grammatically. For example, the word finder 505 finds definite and indefinite articles, verbs, and verb types, adjectives, adverbs, words specific to claim grammar, punctuation, formatting, etc. Words specific to claim grammar include, for example, the words “claim”, “comprising”, or any other words that have specific meaning regarding the structure of a claim. The word finder 505 further classifies groups of words in similar manner, including, for example, “consisting of”, “means for”, “the step of”, etc. The word finder 505 may receive input from the text 320 or from the units of claim text data 325. The word finder 505 outputs the words found to the units of claim text data 325.

The claim dependence finder 510 searches for text within the claim corresponding to the claim dependence. The claim dependence finder 510 searches, for example, for the word “claim” followed by a number (1, 2, 3, etc.). The claim dependence finder 510, further searches for words and groups of words indicating claim dependence, for example, “according to claim”, “any one of proceeding claims”, etc. in particular, the claim dependence finder 510 checks that multiple dependent claims are indicated in an appropriate manner in accordance with US practice. For example, “in accordance with claims 1 and 2”, is not acceptable because in US practice a claim can only be dependent on one claim at a time and not more than one claim simultaneously. The claim dependence finder 510 compiles a list of claim numbers for each claim corresponding to that claim's dependence. If the dependence of the claim changes, the claim dependence map 330 is updated by the claim dependence finder 510.

The clause finder unit 515 reads through the claim searching for words and phrases indicating clauses such as “comprising:”, “comprising”, etc. Based on these words and phrases and punctuation, such as “;” and “,”, the clause finder unit 515 finds each element in the clause. If there is more than one element in the clause the claim finder unit 305 searches for an appropriate “, and” or “; and”. The clause finder unit 515 attempts to arrange the clauses found in a combination of nested hierarchies and linear sets of nested hierarchies, based on the language of the claim. If no logical way is found to arrange the clauses in a combination of nested hierarchies and linear sets of nested hierarchies, then the clause finder unit 515 generates errors indicating, for example, a missing “and” or indicating that a particular clause does not appear to have an end, etc. A linear set of nested hierarchies would be, for example, a first comprising clause inside a first including clause followed by a second comprising clause nested in a second including clause. The clause finder unit 515 also searches for “, or” or “; or” instead of “and”. Any errors are added to the claim error list 335, along with the claim number 105 and the position of the error in the claim. The errors are displayed in the error text box 415.

The antecedence finder unit 520 searches for antecedence bases for features in the claim. The antecedence finder unit 520 may use a number of techniques. In some embodiments, the antecedence finder unit 520 searches for features following a definite article, for example, “the”, “said”, “each”, etc. Having found a feature following a definite article, the antecedence finder unit 520 searches backwards in the claim and then back through the base claims of the claim for the same feature but proceeded by an indefinite article or no article. In some embodiments, the text corresponding to the feature is modified before searching back in the claim and the base claims. For example, if the feature is “the first car” the antecedence finder unit 520 may search for “a first car”, “a first and second car”, “a first and third car”, “a first and a second car”, etc. In some embodiments, the antecedence finder unit 520 may change the word order, as well as the words when searching backwards in the claim and the base claims. For example, if the feature is “the stored data” the antecedence finder unit 520 may search for “stored data”, “storing data”, “to store data”, “storing the data”, “to store the data”, “to store the first data”, “storing, using the computer, the first data”, etc. The antecedence finder unit 520 may transform the feature in any manner consistent with the English language, or the language of the claims, that could reasonably be considered to correspond to an antecedence base for the feature. In some embodiments, the antecedence finder unit 520 searches for features beginning with an indefinite article or no article and then searches backwards in the claim and the base claims for similar features beginning with a definite, indefinite article or no article to check for duplication of an antecedent base.

In some embodiments, the antecedence finder unit 520 searches for base features beginning with an indefinite article or no article and then searches forward in the claim and dependent claims for similar features beginning with a definite article. The antecedence finder unit 520 may use similar transformations of words and word order discussed above to search for the similar features. In some embodiments, the antecedence finder unit 520 also searches forward in the claim and dependent claims for similar features beginning with an indefinite article or no article to find duplicate antecedent bases.

During the searches, the antecedence finder unit 520 notes, the relationships between correct antecedent bases and other features, and notes errors, which are collected in the claim error list 335 with appropriate claim numbers and word positions. The errors in the claim error list 335 are displayed in the error text box 415.

The grammar checker 525 checks for grammar errors, for example, duplicate words or punctuation, words that should not be placed next to each other, such as “a” and “the”. The grammar checker 525 checks for a capital letter at the beginning of the claim, a period at the end of the claim, etc. The grammar checker 525 also checks for appropriate capitalizations or acronyms. For example, if the text of the claim recites “the unidentified flying object (UFO) the grammar checker 525 checks that the letters UFO correspond to the first letters of the previous words, first letters of the previous words excluding words like “of”, “the”, etc., the first letters of parts of hyphenated words, or combinations of the above. If the grammar checker 525 cannot find a reasonable way to map the letters in the capitalization or the acronym, the grammar checker 525 will add an error to the claim error list 335 along with the claim and the position in the claim. The error is also listed in the error text box 415. Acronyms or capitalizations found by the grammar checker 525 are also used by the antecedence finder unit 520 to check the antecedence of acronyms in the claims.

The claim status checker 530 checks that the claim status identifier 110 of the claim matches the current state of the text of the claim. For example, if the claim is amended with underlined text or struck through text, the claim status checker 530 verifies that the claim status identifier 110 is either “(Currently Amended)” or “(Withdrawn—Currently Amended)”. If the claim text is not amended, the claim status checker 530 verifies that the claim status does not correspond to an amended claim. If the status of the claim is changed during editing, the claim status checker 530 remembers the previous states of the claim before editing so that if the edits are removed, the claim status identifier 110 can be returned to the original state. For example, the original state might be “(Previously Presented)”. If the claim is now amended, the claim status identifier 110 will change to “(Currently Amended)”. If the applicant then decides to cancel the claim, the claim status identifier 110 will change to “(Canceled)”. If the applicant then decides they will not cancel the claim after all, but keep the amendments, the claim status identifier 110 reverts to “(Currently Amended)”. The applicant may then decide that the amendments are in fact unnecessary and once the amendments are removed, the claim status identifier 110 will revert to “(Previously Presented)”. The claim status checker 530 continuously monitors the state of the text of the claims and the state of the claim status identifiers 110 and keeps the above synchronized. If for some reason the above are not synchronized the claim status checker 530 will add an error to an the claim error list 335, along with the claim number 105 and the error will appear in the error text box 415.

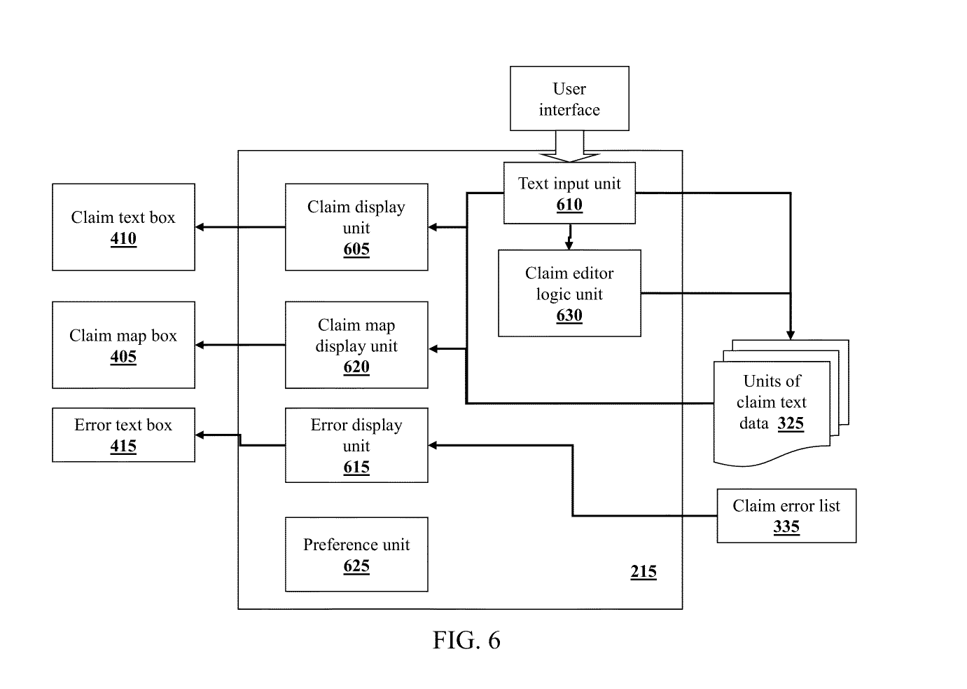

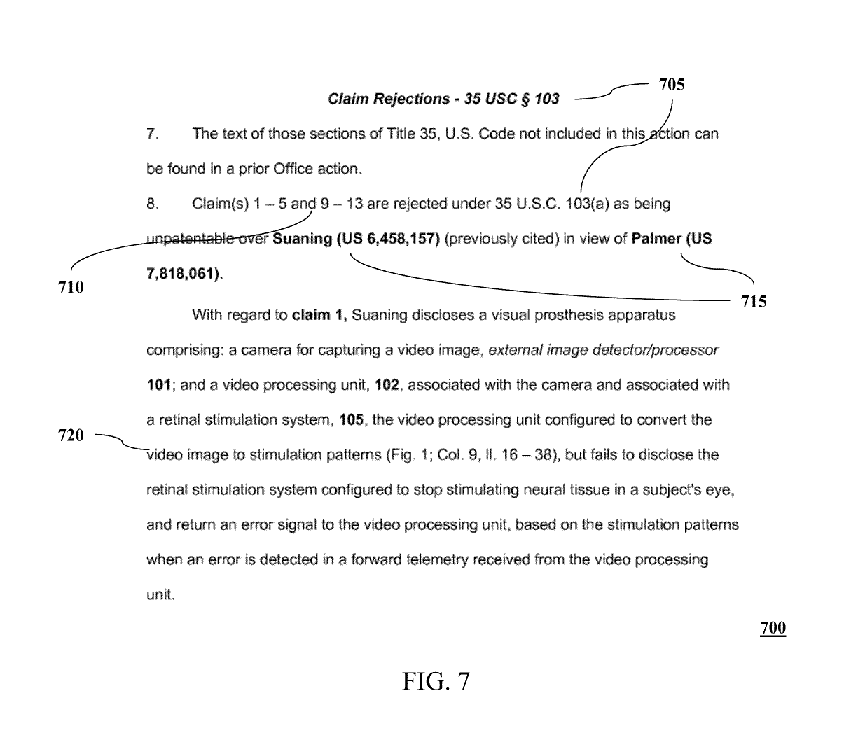

FIG. 6 depicts a claim editor unit 215 according to an embodiment. The claim editor unit 215 comprises a claim display unit 605, a text input unit 610, an error display unit 615, a claim map display unit 620, a preference unit 625, and a claim editor logic unit 630.

The claim editor unit 215 is responsible for gathering keystrokes and other operations such as mouse movements across the claim text box 410 and turning the keystrokes and other operations into edits in the claims. In some embodiments, the claim editor unit 215 obtains the gathered keystrokes and other operations such as mouse movements from, for example, the user interface 250.

The claim editor logic unit 630 filters the keystrokes and other operations to remove keystrokes and operations that are not in compliance with U.S. practice. Further, the claim editor logic unit 630 transforms the keystrokes and other operations to add additional editing commands to force the final edits to be in compliance with U.S. practice. The claim editor logic unit 630 initially marks words in the claims that have already been submitted to the Patent Office. In some embodiments, the claim editor logic unit 630 does not allow these words to be removed other than by striking through the text of these words or enclosing these words in double square brackets. Thus, for example, a backspace might be transformed into selecting a whole word and striking through the whole word. Further, such transformations are used to perform the actions of the claim editor logic unit 630 as discussed below. In some embodiments, the claim editor logic unit 630 automatically selects whether to use strikethrough or double square brackets based on the number of characters in a row deleted. In some embodiments, the claim editor logic unit 630 does not allow portions of words already submitted to the Patent Office to be removed but allows only whole words already submitted to the Patent Office to be removed. In some embodiments, the claim editor logic unit 630 does not allow words that have already been submitted to the Patent Office to have a cursor placed midway through the word, but only at the end and the beginning of the word. Pressing a delete key when the cursor is before a word that has already been submitted to the Patent Office causes the claim editor logic unit 630 to delete the whole word by strikethrough or double square brackets. Similarly, in some embodiments, pressing the backspace when the cursor is behind a word that has already been submitted to the Patent Office causes the claim editor logic unit 630 to delete the whole word by strikethrough or double square brackets. In some embodiments, pressing the cursor keys causes the claim editor logic unit 630 to move over whole words that have been submitted to the Patent Office and the cursor cannot be made to sit in the middle of such words. In some embodiments, if the cursor is between two words that have been submitted to the Patent Office, pressing a valid letter or number causes the claim editor logic unit 630 to insert a new word between the two words. In some embodiments, the claim editor logic unit 630 does not allow additional letters or numbers to be added to the beginning or end of words already submitted to the Patent Office. In some embodiments, the claim editor logic unit 630 allows punctuation to be added to the end of words already submitted to the Patent Office. In some embodiments, if punctuation is added to the end of a word already submitted to the Patent Office, the claim editor logic unit 630 causes the word to be struck through or placed in double brackets and a copy of the word to be added with the punctuation in underlined text format. In some embodiments, the applicant can choose whether punctuation may be added to words already submitted to the Patent Office or whether the words have to be deleted and added with punctuation via the user interface 250.

In some embodiments, the claim editor logic unit 630 allows words that are added by the applicant and have not yet been submitted to the Patent Office to be freely edited. In some embodiments, the claim editor logic unit 630 allows the cursor to be moved to any point in the added words to add or remove individual letters. In some embodiments, the claim editor logic unit 630 does not cause removed letters of whole word or whole words that have been added by the applicant to be struck through, but those letters or whole word are removed completely from the text.

In some embodiments, the claim editor logic unit 630 does not underline or strike through formatting such as carriage returns and tabs when added or when being removed.

If a word that has been submitted to the Patent Office has been deleted by strikethrough or double square brackets that word may be re-added by, for example, placing the cursor before the word and striking the insert key found on most keyboards. In some embodiments, a different combination of keys is used to reinsert words that are strikethrough or in double square brackets.

In some embodiments, if a claim is newly added, the text of the claim may be edited freely. Individual characters in words may be deleted and are not struck through or placed in double square brackets and letters or words that are added are not underlined.

In some embodiments, each time a letter or character is added or removed from the text, the word finder 505, the claim dependence finder 510, the clause finder unit 515, the antecedence finder unit 520, the grammar checker 525, the claim status checker 530, the claim map maker 310, and the claim map checker 315 are called to recheck the errors, rebuild the claim dependence map 330 and the claim map box 405, re-list the errors in the error text box 415, and redisplay the text in the claim text box 410. During this process, the position of the cursor remains fixed. Thus, as the applicant types the amendments to the claims, the claim error list 335, the antecedence, the claim dependence map 330, and the indication of the amendments in the claim text box 410 update in real time. The applicant is thus continuously made aware of errors being removed from and introduced to the claims. In some embodiments, the applicant is also made aware of spelling errors introduced in real time. In some embodiments, each time a letter or character is added or removed from the text, only specific ones of the word finder 505, the claim dependence finder 510, the clause finder unit 515, the antecedence finder unit 520, the grammar checker 525, the claim status checker 530, the claim map maker 310, and the claim map checker 315 necessary are called to recheck the errors, rebuild the claim dependence map 330 and the claim map box 405, re-list the errors in the error text box 415, and redisplay the text in the claim text box 410. In some embodiments, a user is required request the word finder 505, the claim dependence finder 510, the clause finder unit 515, the antecedence finder unit 520, the grammar checker 525, the claim status checker 530, the claim map maker 310, and the claim map checker 315 to recheck the errors, rebuild the claim map and the claim map box 405, re-list the errors in the error text box 415, and redisplay the text in the claim text box 410. In some embodiments, only specific ones of the word finder 505, the claim dependence finder 510, the clause finder unit 515, the antecedence finder unit 520, the grammar checker 525, the claim status checker 530, the claim map maker 310, and the claim map checker 315 necessary are called to recheck the errors, rebuild the claim map and the claim map box 405, re-list the errors in the error text box 415, and redisplay the text in the claim text box 410 only after specific actions by a user. The specific actions by the user include, for example, selecting a different claim, completing a word, removing a complete word, changing a claim number, indicating that the claim editing is complete, or pressing a specific key.

The claim display unit 605 is responsible for converting the underlying word data into the display form in the claim text box 410. The claim text is stored as words, each word having attributes, including for example, whether the word has been submitted to the Patent Office, whether the word is part of an antecedence base, whether the word contains an error, etc. In some embodiments, the claim display unit 605 converts the underlying word data in the units of claim text data 325 into displayed words with different colors, strikethrough, underlined and double brackets. In some embodiments, the claim display unit 605 also deals with pictures in the text, such as equations, and with formatting such as subscript and superscript, which are also attributes that words stored may have. In some embodiments, as the claims are edited, and the underlying word data and the attributes change, the claim display unit 605 converts the underlying word data into the text displayed in the claim text box 410. In some embodiments, the claim display unit 605 only processes the underlying word data to text when a change in the underlying word data is made.

The text input unit 610 is responsible for tracking keystrokes and other operations such as mouse operations. In some embodiments, the text input unit 610 obtains the gathered keystrokes and other operations such as mouse movements from, for example, the user interface 250. The text input unit 610 converts the keystrokes and other operations along with the position of the cursor in the claim text box 410 into changes in the underlying word data of the claims as stored in the units of claim text data 325. The text input unit 610 changes in the underlying word data of the claims as stored in the units of claim text data 325 by using, if necessary, the Claim editor logic unit 630. Thus, for example, if the delete key is pressed and the cursor is before a word that has already been submitted to the Patent Office, that word is marked in the units of claim text data 325 as having been deleted. The claim display unit 605 will then update the text in the claim text box 410 to strikethrough or double bracket the word. A similar process happens for other editing of the text. In some embodiments, the text input unit 610 also deals with cut, paste and copy operations. In some embodiments, if the pasted text is plain text from outside of the patent prosecution preparation unit, the text is first parsed into words and the words are classified by the word finder 505. The words are then added to the units of claim text data 325 for the claim that they are pasted into in the appropriate place. The claim display unit 605 updates the display in the claim text box 410 based on the data in the units of claim text data 325. The claim finder unit 305, word finder 505, the claim dependence finder 510, the clause finder unit 515, the antecedence finder unit 520, the grammar checker 525, and the claim status checker 530 are all used as necessary to check the pasted text along with the rest of the claims. The above elements update the claim error list 335, the error text box 415, the claim dependence map 330 and the claim map box 405 in addition to the claim text box 410.

The error display unit 615 converts the claim error list 335 into text for the error text box 415. In some embodiments, each error has a severity flag attached to it, indicating the severity of the error. Each error has a short text associated with the error, indicating briefly the error, and a long text associated with the error that describes the error in detail. The error text box 415 converts the short texts in the claim error list 335 into text for the error text box 415 and assigns colors appropriate to the severity flag. In some embodiments, if the mouse is rolled over the short text of one of the errors, the long text associated with the error is displayed in a pop-up box. Thus, the applicant can see all of the errors in brief, and if necessary, quickly view the details of the error. In some embodiments, if the applicant selects the brief text of one of the errors, the error position is highlighted in the claim text box 410, and the claim text box 410 is scrolled to the appropriate position (See, for example, FIG. 4F).

The claim map display unit 620 generates the text in the claim map box 405 based on the claim dependence map 330, the claim status identifier of each claim, and the severity of errors in each claim. Each claim is represented as a label with the word “claim” and the claim number. The claim dependence is indicated, as discussed above, by indenting a dependent claim beneath its base claim. In some embodiments, the type of text, for example, italic, bold, strikethrough, grayed out, etc. indicates the claim status, for example, amended, canceled, new, withdrawn, etc. In some embodiments, the color of each claim label indicates the severity of the error in the claim. For example, red indicates a severe error, orange, indicates a warning, and pink indicates advice. In some embodiments, each time the claims are amended, the claim map display unit 620 updates the claim map box 405 based on the claim dependence map 330, the errors in the claims, and the claim status identifier of each claim.

The preference unit 625 deals with preferences that an applicant may have for displaying the claims, for example, the font size and type in the claim text box 410, the claim map box 405, and the error text box 415. The preference unit 625 further allows the applicant to define the fonts and size of fonts for exporting claims using the export button 425. The preference unit 625 also allows the applicant to change the format of each claim. For example, a TAB can optionally be placed before the claim number 105, between the claim number 105 and the claim status identifier 110, and between the claim status identifier 110 and the claim text. The claim status identifier 110 may optionally be made bold. Alternatively, only currently amended claim status identifiers may optionally be made bold.

In some embodiments, the applicant can select some features of the antecedence finder unit 520. For example, some patent practitioners prefer not to have an antecedence base in the preamble 115 of a claim. Other practitioners consider an antecedence base in the preamble 115 of the claim to be acceptable. The preference unit 625 allows the applicant to select whether to search for antecedence bases in preambles of claims. Some patent practitioners consider that the definite article is acceptable when introducing inherent properties of other features. For example, the weight of a car might be considered inherent because all cars have weight. For this reason, the antecedence finder has a list of properties that may be considered inherent. The preference unit 625 allows the applicant to amend the list, and select an option so that the antecedence finder will ignore antecedence for those properties. The preference unit 625 deals with other preferences that an applicant or applicant's representative might have that are compatible with embodiments of the disclosure.

FIG. 7 depicts a portion of a rejection from a Patent Office 700 according to an embodiment. The portion of a rejection from a Patent Office 700 comprises an objection or rejection type 705, claims, drawings, or portion of specification objected to or rejected 710, cited alleged prior art 715, and an Examiner's argument 720.

An Office Action from the Patent Office consists of a series of rejections and/or objections similar to that shown in FIG. 7. Each of the rejections and/or objections must be responded to by the applicant for a response to be considered responsive. Therefore, the applicant has to acknowledge each objection and/or rejection by repeating back in a response, the facts of each objection or rejection. The applicant then makes an argument or indicates how the claims are amended to overcome the objection or rejection. Finally, for each objection or rejection, the applicant requests that the rejection or objections be reconsidered by the Examiner in light of the amendments and arguments. Typically, each objection or rejection follows the format shown in FIG. 7. FIG. 7 is a portion of a rejection for U.S. Pat. No. 8,000,000.

Each section of the rejection begins by indicating the type of objection or rejection. Objections correspond to informalities and mistakes made by the applicant that the Examiner believes need to be corrected. The objections may be as simple as spelling errors, grammar errors, figure labels missing, antecedence issues, etc.

Rejections come in two varieties. The first variety of rejection is based on the specification or the claims not meeting various requirements. A first example of this first kind of rejection corresponds to §101 rejections. §101 rejections are used when the claim material is not material that is allowed to be claimed in the patent, for example, an algorithm. A second example is a §112, first paragraph rejection which is used when the material claimed is not enabled by the specification. That is, not enough detail in the descriptions is provided for somebody to reconstruct the claimed material. A third example is a §112, second paragraph rejection which refers to the claim material not being clearly defined. This may occur because for example, a word in the claims is not definite or not limited enough in its meaning. The word “it” often causes a §112, second paragraph rejection because it is often unclear what the “it” is.

The second variety of rejection corresponds to prior art rejections, meaning that the Examiner has allegedly found the invention in documents, or in some other form before the applicant filed the application. The applicant is thus allegedly not the first inventor. Prior art rejections may be, for example, §102 rejections in which a single piece of prior art is used to reject the claims, §103 rejections in which a combination of pieces of prior art is used to reject the claims, and double patenting rejections in which applications filed by the applicant are used to reject the claims.

As noted above, each of the above objections and rejections follows approximately the pattern shown in FIG. 7 in which the Examiner states the objection or rejection type 705, lists the claims, drawings, or portion of specification objected to or rejected 710, lists the cited alleged prior art 715, if the rejection is a prior art rejection, and then makes an Examiner's argument 720 to explain the reasoning behind the rejection.

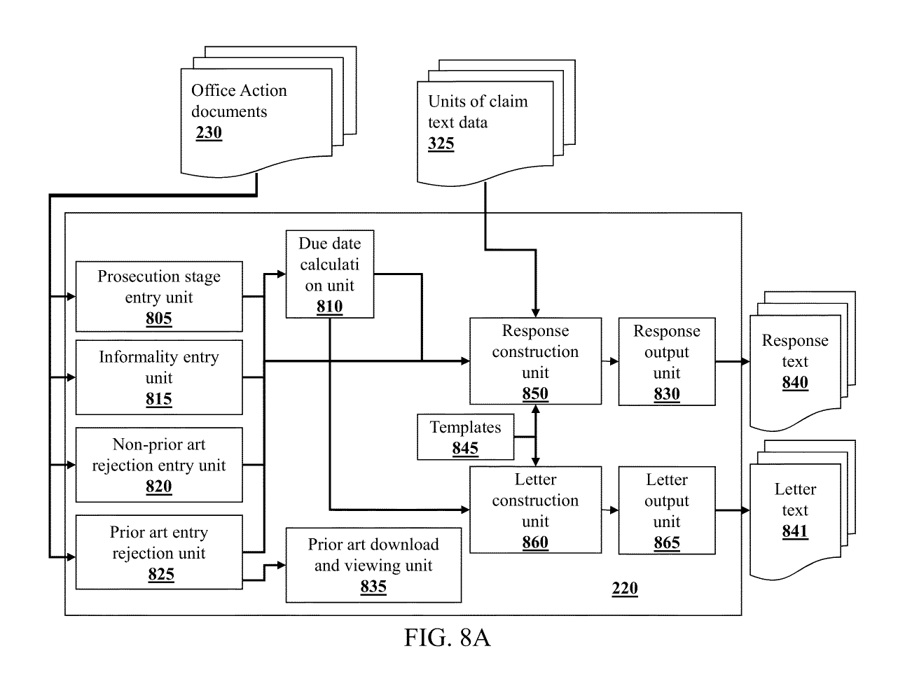

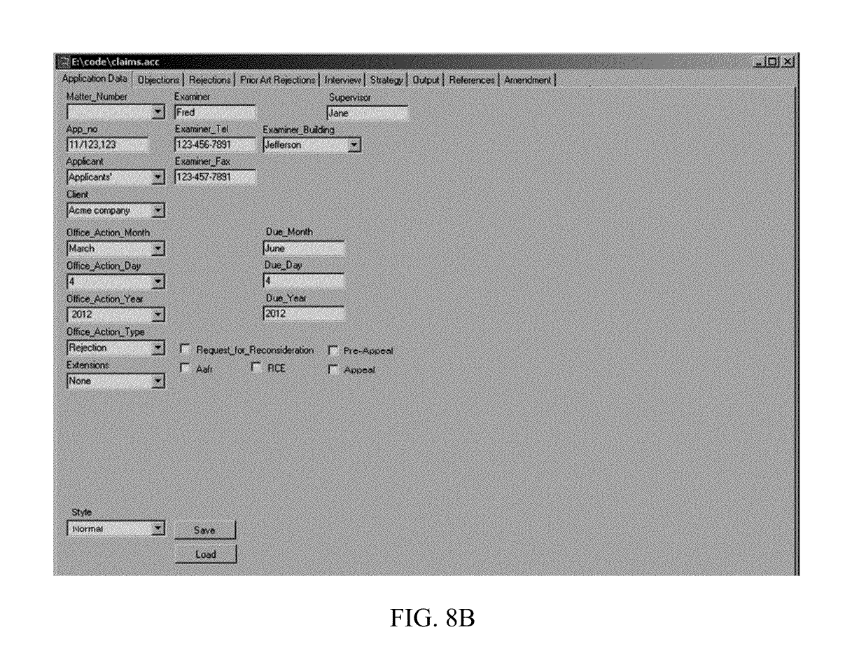

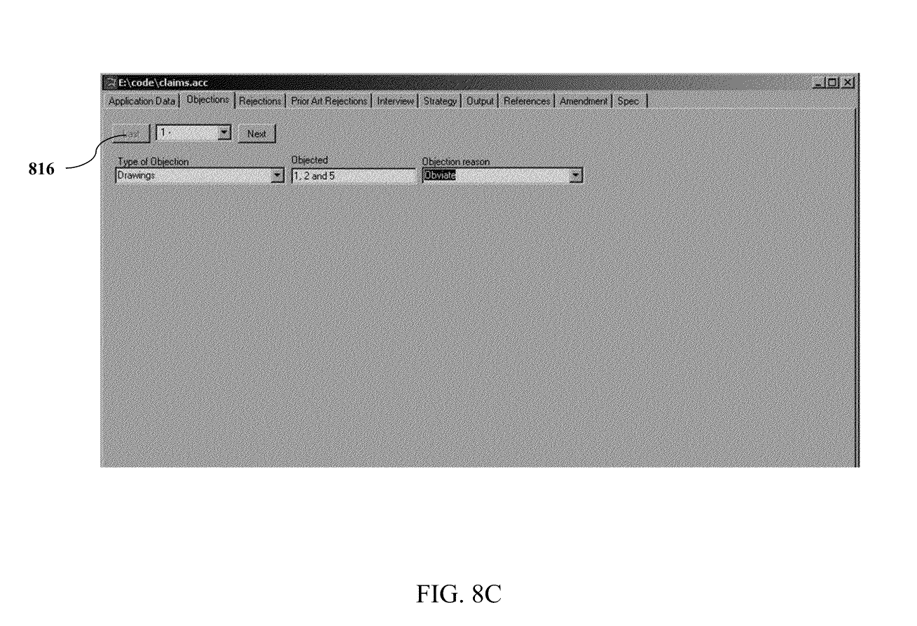

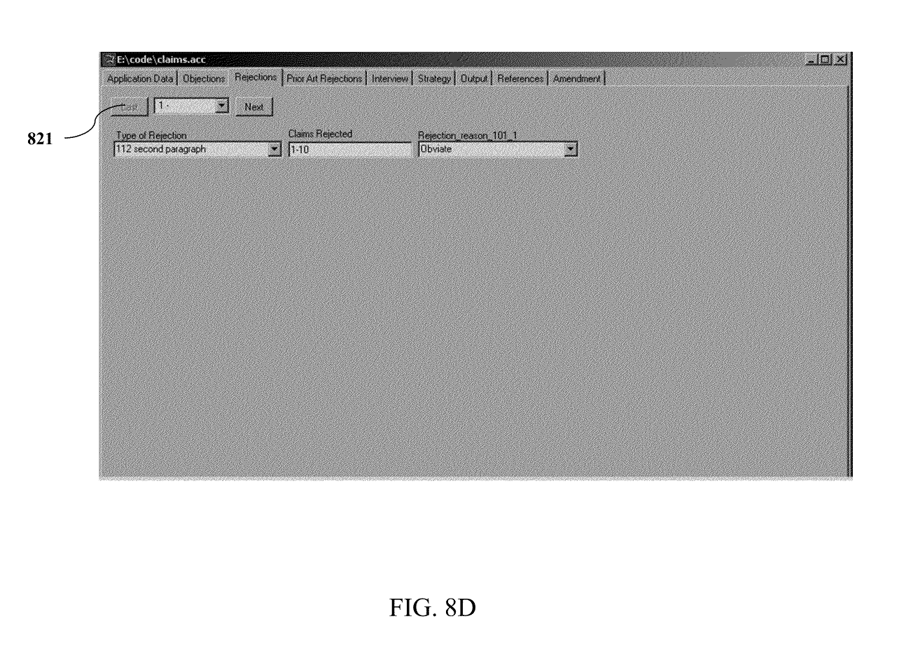

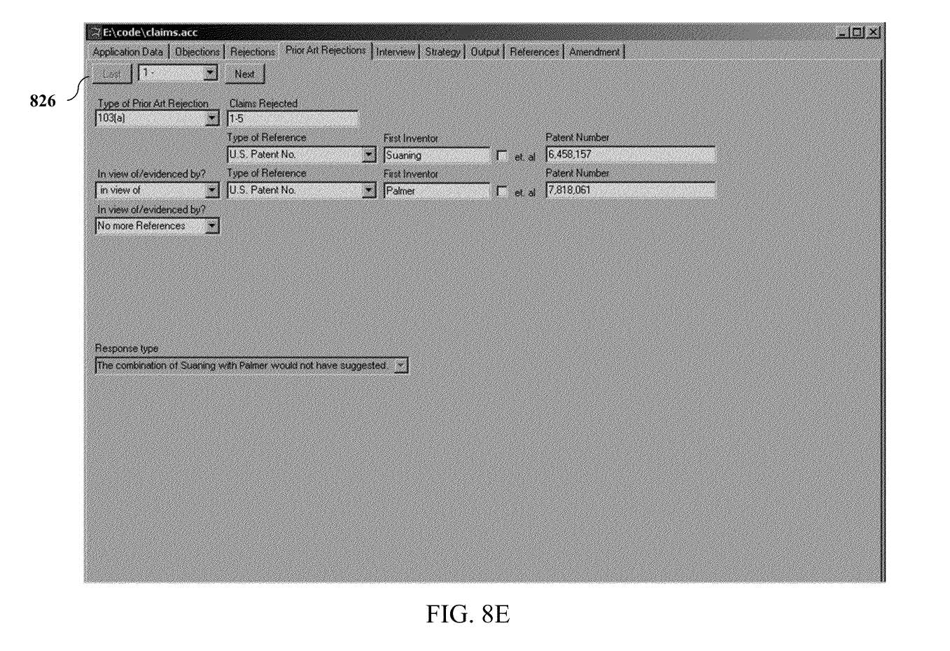

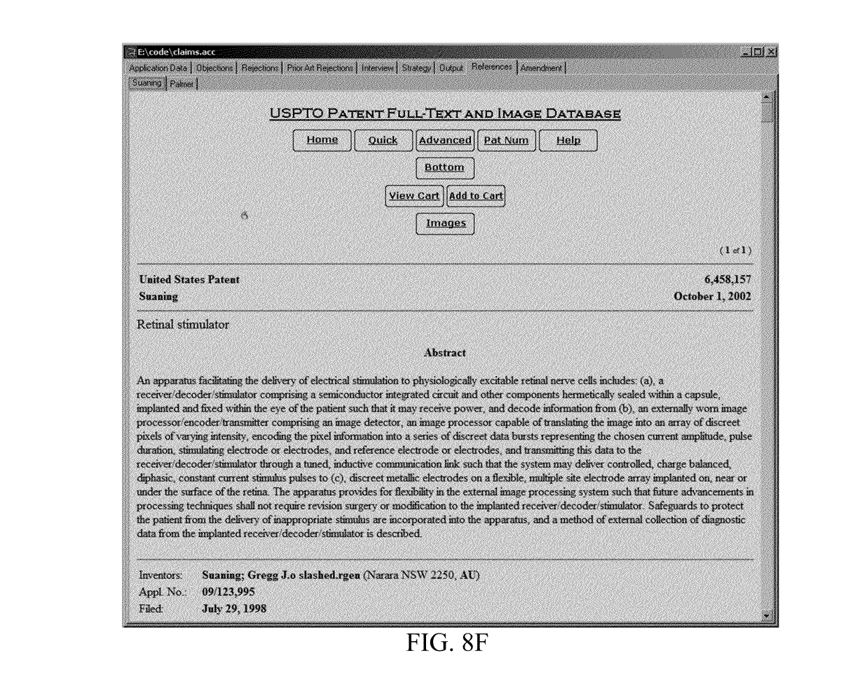

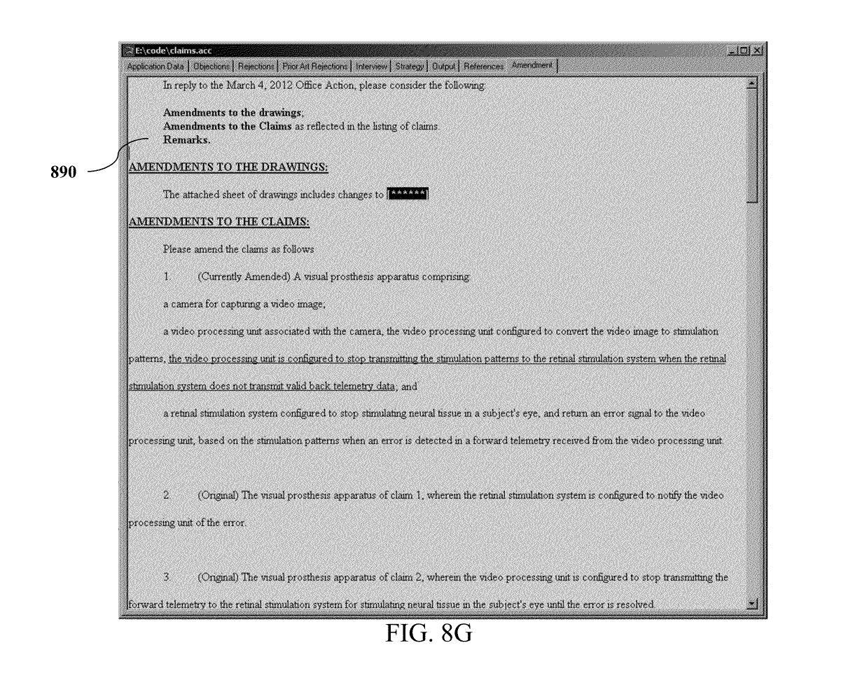

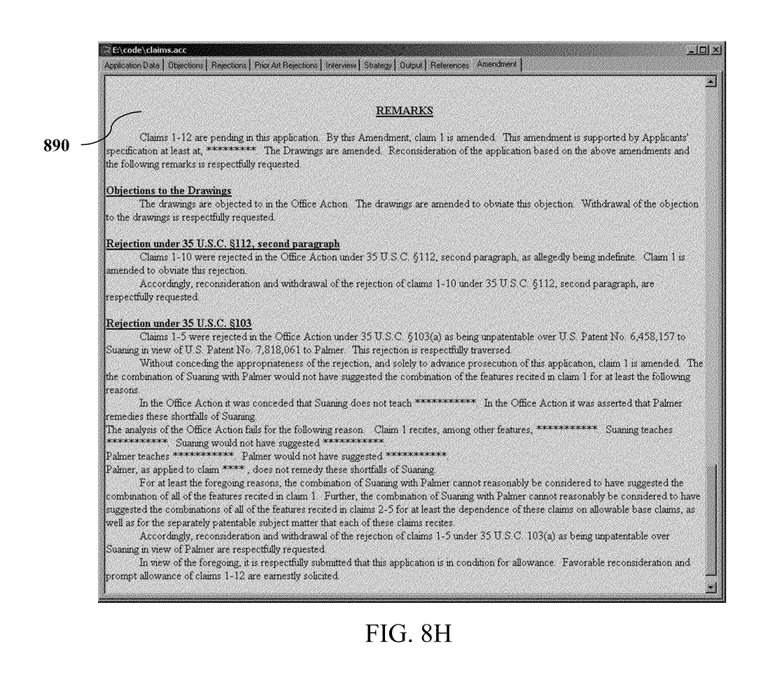

FIG. 8A depicts a prosecution unit 220 according to an embodiment. The prosecution unit 220 comprises a prosecution stage entry unit 805, a due date calculation unit 810, an informality entry unit 815, a non-prior art rejection entry unit 820, a prior art rejection entry unit 825, a prior art download and viewing unit 835, templates 845, an response construction unit 850, an response output unit 830, a letter construction unit 860, an letter output unit 865.

The prosecution unit 220 is used to combine the objections and rejections like that in FIG. 7 with the claim amendments and observations by the applicant to generate portions of text of a response to the Office Action. The text of the response is divided into sections usually there is an introduction indicating the parts of the response. If there are amendments, then the introduction indicates that there are amendments. If there are Remarks in which arguments are made, the introduction indicates that there are Remarks. The next section is usually Amendments. The amendments may be to one or more of the specification, the Abstract, the drawings, or the claims. After the amendments, there is usually a remarks section. The Remarks section begins with a summary list of the pending claims, a list of the amended claims, a list of the canceled claims, and a list of the withdrawn claims.

Following this summary each objection or rejection is addressed, usually in the order the objections and rejections appear in the Office Action. To address each objection or rejection, the response first acknowledges the type of rejection or objection, the claims, drawings or portion in the specification affected, and lists any prior art used for the rejection or objection. For each objection or rejection, the applicant includes an argument as to why the rejection or objection is incorrect, or the manner in which amendments overcome the objection or rejection. Finally, for each objection or rejection, the applicant requests reconsideration and withdrawal from the Examiner. Much of the text of the Response is thus fairly rigid and predictable based on the Office Action.

The prosecution unit 220 presents a series of forms that the applicant can fill in regarding each objection or rejection in the Office Action. Based on how the applicant fills in the forms and based on reading the claim units of text data 325, the prosecution unit 220 is able to construct large portions of the response. In particular, most portions of the response other than the arguments made by the applicant can be constructed this way. This allows the applicant or the applicant's representative to concentrate on the arguments rather than generating large portions of formal text.

The first portion of the forms for the applicant to fill comprises general data regarding the Office Action. This portion of the form is handled by the prosecution stage entry unit 805. In some embodiments, the prosecution stage entry unit 805 obtains the gathered keystrokes and other operations such as mouse movements from, for example, the user interface 250. In some embodiments, a user interface separate from user interface 250 is used. An example of this portion of the form is shown in FIG. 8B. This portion of the form allows the applicant to fill in, for example, the Examiner's name, telephone number, and fax number. The applicant can also enter a matter number for the application if there is a matter number. The applicant can enter the application number for the patent application, the name of the client, and the date on which the Office Action was issued. Based on the date on which the Office Action was issued, the patent prosecution unit calculates the due date for responding to the Office Action. In the example shown in FIG. 8B, the date entered is Mar. 4, 2012. The calculated due date is Jun. 4, 2012, three months after the issue date. The Office Action type is indicated as Rejection; the usual response time for a rejection is three months. Other Office Action types include Final Rejection, Advisory Action, Quayle action, etc. The extensions are for extensions of time. For a Rejection, extensions of time up to three months are allowed in one-month increments. The applicant can select to add an extension if necessary, in which case the due date will be recalculated.

The due date calculation unit 810 uses the date of the Office Action, the type of Office Action, for example, Rejection, Final Rejection, Advisory Action, etc., and the number of extensions (in the Extensions box in the form) entered into the prosecution stage entry unit 805 to calculate the due date. In some embodiments, the form, as shown in FIG. 8B, is automatically updated with the due date (in the due month, day, and year boxes). In some embodiments, the due date is used to enable a docketing system to docket the due date and to send reminders to the applicant to file a response.

The check boxes marked Request for Reconsideration, Aafr (Amendment after Final Rejection), RCE (Request for Continued Examination), Pre-Appeal, and Appeal, allow the applicant or applicant's representative to select the type of response to be generated. Depending on the type of Office Action, some of the check boxes may not be available. For example, RCE (Request for Continued Examination) is not available if a rejection is non-final.

FIG. 8C shows the portion of the form attached to the informality entry unit 815 for entering informalities documented in the Office Action. The informality entry unit 815 comprises an informality selector 816. Selecting the “next” button of the informality selector 816 moves to the next informality. Selecting the “last” button of the informality selector 816 moves to the previous informality. Informality 1 is shown in FIG. 8C. The type of informality is an objection to the drawings. In particular, FIGS. 1, 2 and 5 have objections. In the case of FIG. 8C, the applicant has chosen to obviate the rejection. This is selected in the rejection reason box. Obviate means that the applicant has chosen to amend rather than to argue. The applicant could have chosen to argue with the objection to the figures. Other objection types that can be selected include objections to specification, the abstract, the claims, or the title. Based on the objections listed in the form shown in FIG. 8C, the informality entry unit 815 sends information to the response construction unit 850. The response construction unit 850 builds text for responding to the objection. FIG. 8H shows the text built by the response construction unit 850 for responding to the objection. The text is the title “Objections to the drawings” and the paragraph below the title “Objections to the drawings.”

The informality selector 816 allows the applicant to select and to add additional informalities, and select an informality to edit. Pushing the “next” button moves to the next informality, and pushing the “last” button moves to the previous informality. In FIG. 8C, informality “1” is selected.

The non-prior art rejection entry unit 820 allows the applicant to enter non-prior art rejections under the portion of the form shown in FIG. 8D. The non-prior art rejection entry unit 820 comprises a non-prior art selector 821. The non-prior art selector 821 allows the applicant to select the non-prior art rejection. Pushing the “next” button of the non-prior art selector 821 moves to the next informality, pushing the “last” button of the non-prior art selector 821 moves to the previous informality. The applicant may then select the type of rejection, for example, §101, §112, first paragraph, §112, second paragraph, etc. In the “Claims Rejected” box, the applicant can enter the claims rejected as a list. In the box after the claims under rejection reason, the applicant can enter a proposed response. In FIG. 8D, the proposed response is to obviate the rejection, which means amending the claims to remove the rejection. Other possible responses may be to argue with the rejection or render the rejection moot by canceling the claims. The response construction unit 850 builds text for responding to the rejection, based on the selections made by the applicant in the non-prior art rejection entry unit 820. FIG. 8H shows the text built by the response construction unit 850 for responding to the rejection. The text is the title “Rejection under 35 U.S.C. §112, second paragraph” and the paragraph below that title.

The non-prior art selector 821 allows the applicant to add additional new non-prior art rejections, and select a non-prior art rejection to edit. Pushing the “next” button moves to the next non-prior art rejection, pushing the “last” button moves to the previous non-prior art rejection. In FIG. 8D, non-prior art rejection “1” is selected.

The prior art rejection entry unit 825 allows the applicant to enter prior art rejections under the portion of the form shown in FIG. 8E. The prior art rejection entry unit 825 comprises a prior art selector 826. The prior art selector 826 allows the applicant to select the prior art rejection. The applicant may then select the type of rejection, for example, §102(a), §102(b), §102(e), §103(a), nonstatutory double patenting, etc. In the next box, the applicant can enter the claims rejected as a list. In example shown in FIG. 8E, claims 1-5 are rejected.

The prior art rejection entry unit 825 allows the applicant to enter the prior art from the Office Action. As shown in FIG. 8E, for each alleged piece of prior art, the applicant selects a type of reference, for example, a U.S. Patent, a US patent application, a co-pending application (for nonstatutory double patenting rejections), a Japanese application or patent, a Korean patent application or patent, a PCT application, a book, a journal publication, etc. Based on the type of reference, the prior art rejection entry unit 825 filters subsequent entries regarding the alleged prior art reference. The next piece of information for the applicant to enter for the alleged prior art is the first inventor. If the applicant had selected a book for the type of reference, the applicant would have been asked for the first book author rather than inventor. The “et. al” checkbox allows the applicant to indicate if there is more than one author or inventor. The final text box for the piece of alleged prior art is labeled “patent number” in the example shown in FIG. 8E. If the applicant had selected a book for the reference type, the text box labeled “patent number” would have been labeled “title, and date of publication.” If the applicant had selected a journal publication for the reference type, the text box labeled “patent number” would have been labeled “title, journal, volume, and date of publication.” The applicant is thus prompted to enter the correct information regarding the reference. In some embodiments, a user may fill in only some of the above prior art fields directly. The prior art rejection entry unit 825 then allows the user to automatically fill the remaining field by accessing local or Internet based databases such as the U.S. Patent Office patent search database.

The “in view of/as evidenced by box” allows the applicant to select from a list of possibilities indicating how the Examiner is using a combination of references. For example, in FIG. 7, the Examiner rejects the claims over Suaning “in view of” Palmer. As shown in FIG. 8E the prior art rejection entry unit 825 has allowed the applicant to enter all of the information regarding the rejection, as shown in FIG. 7, except for the argument presented by the Examiner. However, in the box marked “rejection type” in FIG. 8E, the applicant is able to select from templated arguments to place in the response to the office action. The applicant has selected the argument “The combination of Suaning with Palmer would not have suggested . . . ”. The results of this selection and other information filled into the prior art rejection entry unit 825 as shown in FIG. 8E can be seen in FIG. 8H under the title “rejections under 35 U.S.C. §103.” The “********” portions in FIG. 8H indicate places where the applicant still needs to fill in the details of the argument. Based on the data entered into the prior art rejection entry unit 825, the response construction unit 850 has used the templates 845 to construct a reasonably detailed argument without any aid from the applicant. For example, the response construction unit 850 recognized that claim 1 is amended and added language to account for the amendment. The response construction unit 850 recognized that claim 1 is independent and, therefore, constructed an argument based on the amendment to the independent claim. The dependent claims are argued as overcoming the applied references based on these claims dependence on claim 1. Thus, the response construction unit 850 is capable of performing a great deal of logical analysis on the rejection, the current state of the claims and whether the claims are dependent or independent to construct the response text. This saves the applicant considerable time, and prevents errors. For example, if all of the claims in a rejection are rejected, the response construction unit 850 will construct language indicating that the rejection is moot. Further, the response construction unit 850 does not assert that canceled claims are in condition for allowance or ask for reconsideration or withdrawal to rejections of canceled claims. The response construction unit 850 builds lists of claims for each portion of the response being constructed based on the claims in the objection or rejection, the claims that are canceled, and the claims that are amended. For each objection or rejection, the response construction unit 850 builds a list of claims in the objection or rejection, a list of claims amended in the objection or rejection, a list of independent claims in the objection or rejection, a list of dependent claims in the objection or rejection, a list of canceled claims in the objection or rejection, a list of amended independent claims in the objection or rejection, a list of amended dependent claims in the objection or rejection, a list of not-canceled claims in the objection or rejection, a list of not-canceled independent claims in the objection or rejection, a list of not-canceled dependent claims in the objection or rejection, etc. When constructing templates 845, the applicant or applicant's representative can use any of the above as tag words in the templates 845. Further, the applicant or applicant's representative can use any of the above to cause portions of template to be used or not used. For example, if the list of not-cancel claims in the rejection is empty, a portion of the template that recites, “The cancelation of \CLAIMS_IN_REJECTION renders this rejection moot.” is used. Thus, the templates 845 can have IF THEN ELSE constructions. For example, “\IF \NON_CANCELED_CLAIMS=“ ” THEN “The cancelation of \CLAIMS_IN_REJECTION renders this rejection moot.”

The prior art selector 826 allows the applicant to add additional informalities, non-prior art rejections or prior art rejections to the response. Further, the selector 826 allows selection of an entry already entered in the informality entry unit 825 for editing. Pushing the “next” button moves to the next prior art rejection, pushing the “last” button moves to the previous prior art rejection. In FIG. 8E prior art rejection “1” is selected.

The prior art download and viewing unit 835 takes as input the alleged prior art references input to the prior art rejection entry unit 825. Based on the references, the prior art download and viewing unit 835 automatically attempts to download the references. If, for example, the references are US patent references, the prior art download and viewing unit 835 constructs an Internet address for the US Patent Office database based on the U.S. reference. If the reference corresponds to a book, the prior art download and viewing unit 835 constructs a search request, for example, in Google™ books.

FIG. 8F shows the result of the prior art download and viewing unit 835 search for the references shown in FIG. 8E. Each reference is shown in a separate tab. As can be seen, the Suaning reference has been correctly found. As soon as an alleged prior art reference has been entered into the prior art rejection entry unit 825, the prior art download and viewing unit 835 attempts to load a web page corresponding to the reference. This feature saves considerable time, as it allows the applicant, patent agent, or patent attorney to check rapidly that the reference is correctly identified by the Examiner, and that it is correctly entered into the patent prosecution preparation unit 200. The applicant, patent agent, or patent attorney can also to find the date of the reference to check that the reference is a prior art reference, etc. Each tab produced by the prior art download and viewing unit 835 acts as a fully functioning web page. The applicant, patent agent, or attorney may navigate each reference found in a similar manner to that in any web browser. In some embodiments, the prior art download and viewing unit 835 reads data from any of the web pages and automatically verifies the correctness of, for example, dates, authors, titles, pages etc. of the reference as entered by the applicant, patent agent, or patent attorney. Further in some embodiments, the prior art download and viewing unit 835 requests the priority date of the application in prosecution and attempts to verify that the references are prior to the priority date. The prior art download and viewing unit 835 reports any errors, inconsistencies or priority date issues to the user via, for example, user interface 250.

The templates 845 contain templates of text for various portions of the response. Different attorneys and patent agents prefer different language when responding to an Office Action. For example, one attorney may prefer “The Office Action rejects claims 1-5 under 35 U.S.C. §103(a)”. Another attorney may prefer “Claims 1-5 are rejected under 35 U.S.C. §103(a)”. The templates 845 allow an agent or attorney to switch to a preferred style. A template from the templates 845 can be selected using the Style box as shown in FIG. 8B. Further, the applicant can change one or more of the templates 845 to customize the generated text and create a new style.

Text that changes with the response, for example, lists of claim numbers, prior art references, types of rejection, etc., is entered into the templates 845 using tagged text characters, similar to the rich text file (RTF) commands. For example, the template for the above example reads, “The office action rejects \CLAIMS_REJECTED under \REJECTION_TYPE.” When the response text is constructed, the tag “\CLAIMS_REJECTED” is replaced by “claims 1-5,” and “\REJECTION_TYPE” by “35 U.S.C. §103(a)”. The replacement is performed in a similar manner to a mail-merge feature in, for example, a word processing program.

\CLAIMS_REJECTED and \REJECTION_TYPE are one of a large number of tags that are selectable. As the response construction unit 850 works through the various forms, the response construction unit 850 finds values for the tags if possible. Any variable data entered into the forms can be a tag with an associate value. Further, any value that can be derived from the data entered into the forms and from analyzing the claim status and claim dependence in the original and amended claims can be a tag that is selectable by the applicant when constructing or editing the templates 845. Moreover, the tags and the values of the tags can be used in IF_THEN_ELSE type constructions in the templates to change the text produced by the response construction unit 850.

In some embodiments, the templates 845 are edited by opening and editing text files corresponding to the templates 845 using a text editor. In some embodiments, the templates 845 are edited by clicking on a portion of text in the response text 840 as shown in FIGS. 8G-H. Clicking on a portion of the response text 840 causes the underlying template for that portion of text to be opened in a text editor. Thus, while reading the response text 840, the applicant is able to identify language in that is not acceptable, open the template, and edit and save the template. If the same edited template is used again in a future amendment, the language will then still be acceptable to the applicant.

The response construction unit 850 takes the outputs from the prosecution stage entry unit 805, the informality entry unit 815, the non-prior art rejection entry unit 820, the prior art entry projection unit, the templates 845, and the claim units of text to generate the response text 840. If the claims are amended, the response text 840 includes the amendments to the claims. If the drawings have been indicated as being amended, the response text 840 includes text for indicating that the drawings have been amended. This text is shown in FIG. 8G under the title “amendments to the drawings.” In some embodiments, red text indicates a space for the applicant to enter precisely which drawings are amended. A similar process happens for amendments to the specification, amendments to the title, amendments to the abstract, etc. As noted above, the precise wording of the text for the above items can be changed by amending the templates 845 including tag text that is replaced by the data entered into the forms. Thus, for example, if a specific drawing number is entered into the form and a template contains tag text for a drawing number, when the amendment constructor unit 850 constructs the response, the tag text is replaced by the specific drawing number. Similar templates 845 exist for all portions of possible responses, including the introduction to the remarks, the objection text, the non-prior art rejections text, the prior rejection text, the conclusion, etc. Thus, by selecting and/or modifying templates 845, the applicant can adapt the text to their particular taste. The templates 845 may be advantageous for a particular law firm because, by requiring all attorneys to use a particular set of templates 845 for style, the language of responses becomes the same across the law firm. This allows the knowledge and experience of many attorneys to be pooled into the templates 845.

The response output unit 830 converts the output from the response construction unit 850 into text and displays the response text as shown in FIGS. 8G-H. The text in the response box 890 shown in FIGS. 8G-H can be copied and pasted into, for example, a Word™ document for final editing and submission to the Patent Office.

The applicant is thus, guided through the Office Action by the form-filling process as discussed above. In some embodiment, the form is smart and, based on input by the applicant, limits the choices available to the applicant, when, for example, choosing responses or arguments to make to the Patent Office. The patent prosecution preparation unit 200 enables a less well-informed or skilled patent agent, patent attorney, or applicant to make better, more accurate responses to Office Actions by providing guidance. Because the patent prosecution preparation unit 200 reads the amended claims to construct the response, the response and the amended claims are always consistent. Further, because the patent prosecution preparation unit 200 forces the applicant to amend the claims in a manner consistent with Patent Office guidelines, fewer noncompliant amendments are filed. Moreover, the applicant, patent agent, or patent attorney saves considerable time when preparing a response because much of the information required for preparing a response is available in the same set of forms as the claims and the response being constructed. Analysis of the Office Action, amendment of the claims, and preparation of a response typically takes an experienced agent or attorney, four to eight hours depending on complexity. The patent prosecution preparation unit 200 typically reduces the time to prepare a response by between one and three hours and considerably reduces the number of errors.

The letter construction unit 860 constructs text for a letter to an applicant for the patent 841 based on the words of the patent claims, the words of the amended patent claims, and the information regarding the office action. The action of the letter construction unit 860 is similar to that of the response construction unit 850. Templates 845 may be used to construct the text for a letter to an applicant for the patent.

The letter output unit 865 outputs the text for a letter to an applicant for the patent 841 The action of the letter output unit 865 is similar to that of the response output unit 850.

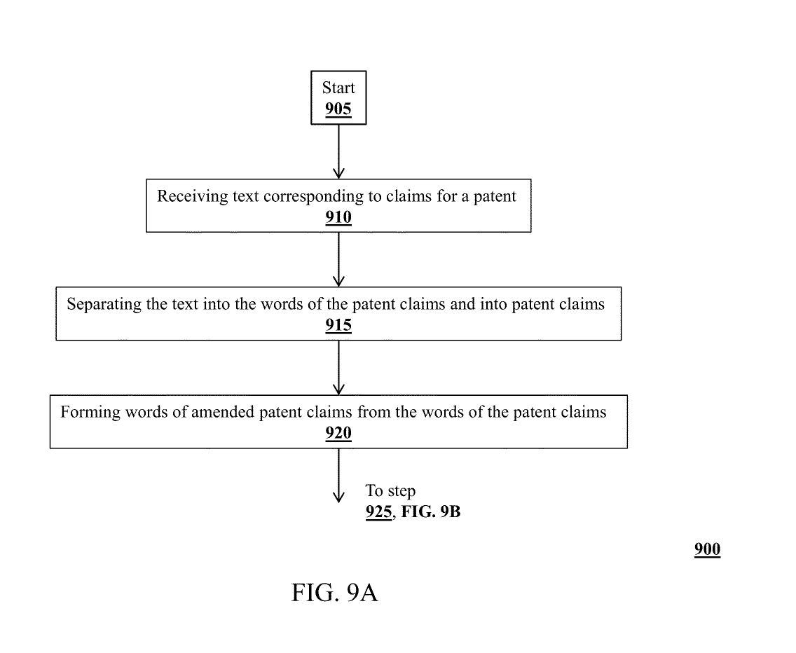

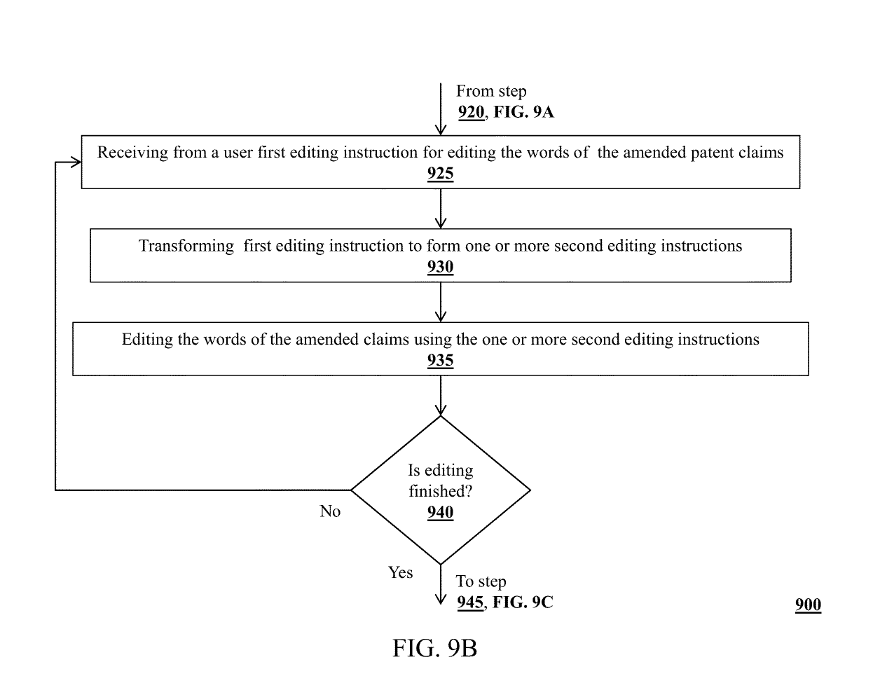

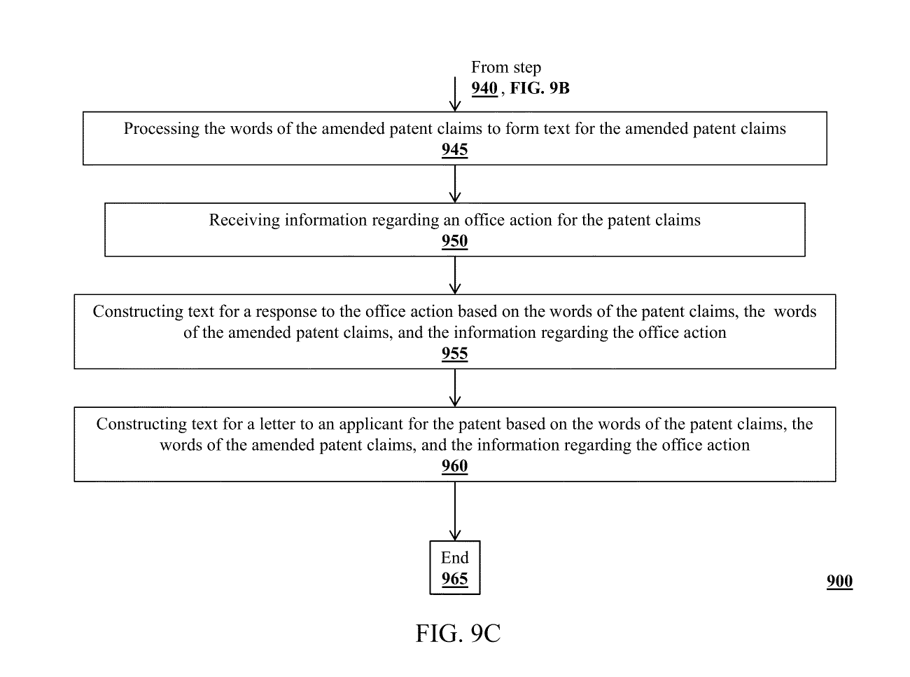

FIG. 9A-C depict a method 900 for editing patent claims according to an embodiment.

The method begins at step Start 905 and proceeds to step 910.

At step 910, information corresponding to claims for a patent is received by, for example, patent prosecution preparation unit 200. In some embodiments, the information corresponding to the claims is received by text being copying from a document using copy and paste features of an operating system. The text copied into the clipboard of the operating system is then pasted into, for example, the claim set analysis unit 205. In some embodiments, the information corresponding to the claims is received by, for example, the claim set analysis unit 205 opening a file with the claim information therein, for example, a Microsoft Word™ document, an RTF file, etc. and copying claim information. When step 910 is complete, the method proceeds to step 915.

At step 915, the claim information is separated into the words of the patent claims and into patent claims. In some embodiments, format characters like TAB and CR are considered to be words. Further, in some embodiments, punctuation marks are also considered to be words. The process for separation into words is similar to that described above for the claim finder unit 305. When step 915 is complete, the method proceeds to step 920.

At step 920, the words of the patent claims found are copied to form words of amended patent claims. If no amendments are made then the words of the patent claims and the words of the amended patent claims will often remain identical. However, even if no amendments are made to the claims, claim status identifiers will be updated if necessary. For example, claims indicated as “New” may become “Previously Presented.” In some embodiment, any future amendments are made to the words of the amended claims, preserving the words of the claims for future reference. When step 920 is complete, the method proceeds to step 925.

At step 925, a first editing instruction is received from a user for editing the words of the amended patent claims 925. The first editing instruction may be input to, for example, the user interface 250. The first editing instruction corresponds to, for example, pressing a letter key on a keyboard, pressing a delete key, etc. When step 925 is complete, the method proceeds to step 930.

At step 930, the first editing instruction is transformed to form one or more second editing instructions. The transformation can be any of the transformations with respect to the claim editor logic unit 630 discussed above. The transformations are based on the current state of words of the amended claims. Thus, for example, if a word has been added to the words of the amended claims, edits to that word will allow deletions of single characters because this added word has not been presented to the patent office. The transformations also produce second instructions that edit the text in compliance with patent office requirements, for example, in the use of double brackets. When step 930 is complete, the method proceeds to step 935.

At step 935, the words of the amended claims are edited using the one or more second editing instructions 935. When step 935 is complete, the method proceeds to step 940.

At step 940, a check is made to see if editing is finished. If editing is finished, the method proceeds to step 945. If editing is not finished, the method returns to step 925 to receive the next first editing instruction.

At step 945, the words of the amended patent claims are processed to form text for the amended patent claims 945. The text may be in the form of, for example, a text file or RTF file. When step 945 is complete, the method proceeds to step 950.

At step 950, information regarding an office action for the patent claims is received by, for example, user interface 250. The information regarding an office action for the patent claims may use the processes described with reference to the prosecution stage entry unit 805, the due date calculation unit 810, the informality entry unit 815, the non-prior art rejection entry unit 820, the prior art rejection entry unit 825, and the prior art download and viewing unit 835, as discussed above. Thus, placing the office action information in a form that can be processed by, for example, a computer. When step 950 is complete, the method proceeds to step 955.

At step 955, a text for a response to the office action is constructed and output based on one or more of the words of the patent claims, the words of the amended patent claims, and the information regarding the office action 955. The text for the response to the office action is produced in a similar manner to that described for the response construction unit 850 and the response output unit 830 and uses templates similar to templates 845. When step 955 is complete, the method proceeds to step 960.

At step 960, text for a letter to an applicant for the patent is constructed and output based on one or more of the words of the patent claims, the words of the amended patent claims, and the information regarding the office action. The above is performed in a similar manner to that for the response construction unit 850 and the response output unit 830 but using the letter construction unit 860 and the letter output unit 865. Templates similar to templates 845 may be used to construct the text for a letter to an applicant for the patent. When step 960 is complete, the method proceeds to step 965.

At step 965, the method terminates.

The above method 900 is merely an example. The order of the above steps may be altered in any manner compatible with embodiments of the disclosure. Further, steps may be omitted or repeated at any point in the method. Additional steps may be inserted before the method, after the method, or in between the method steps discussed above.

Although the above description is based on U.S. practice, it should be clear that the above techniques are adaptable to any patent system. Thus, patent claim editing and response preparation for other patent offices and systems are within the scope of the embodiments of this disclosure.

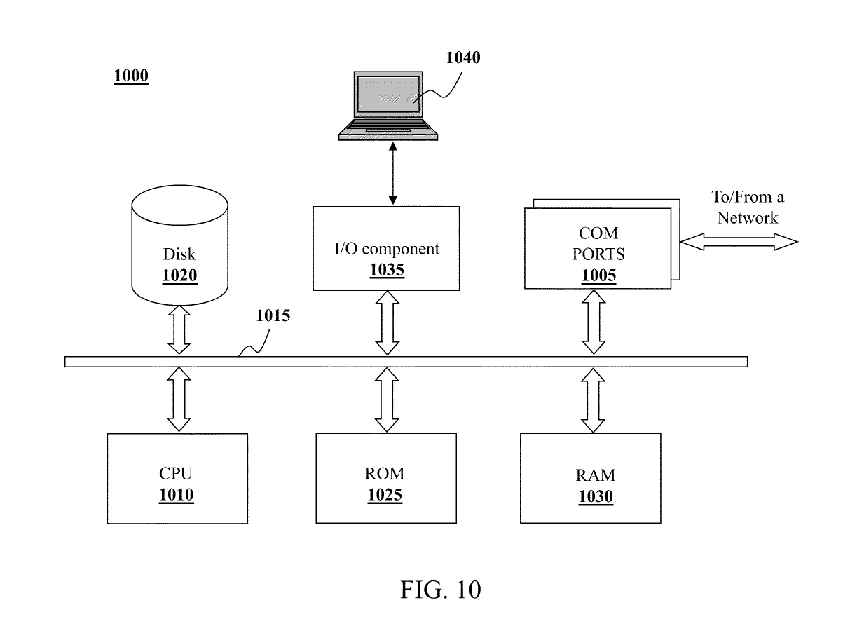

FIG. 10 depicts a computer architecture 1000 on which embodiments of the disclosure can be implemented. The computer architecture 1000 comprises COM ports 1005, a central processing unit (CPU) 1010, an internal communication bus 1015, a disk 1020, a read only memory (ROM) 1025, a random access memory (RAM) 1030, an I/O component 1035, and a user interface 1040.

The computer architecture 1000 may be a general-purpose computer or a special purpose computer. This computer can be used to implement any components of the patent prosecution preparation unit 200 or the method 900. For example, the claim set analysis unit 205, the claim checker unit 210, the claim editor unit 215, and the prosecution unit 220, can all be implemented on a computer such as computer architecture 1000, via its hardware, software program, firmware, or a combination thereof. Although only one such computer is shown, for convenience, the computer functions relating to that patent prosecution preparation unit 210 may be implemented in a distributed fashion on a number of similar platforms, to distribute the processing load.

The COM ports 1005 connect the general computer architecture 1000 to and from a network connected thereto to facilitate data communications. The central processing unit 1010 may be in the form of one or more processors, for executing program instructions. The various data files to be processed and/or communicated by the computer as well as possibly program instructions to be executed by the central processing unit 1010 may be stored on the disk 1020, the read only memory 1025, or the random access memory 1030.

The I/O component 1035 supporting input/output flows between the computer and other components therein such as the user interface 1040. The computer may also receive programming and data via network communications.

Hence, aspects of the methods of patent prosecution and preparation, as outlined above, may be embodied in programming. Program aspects of the technology may be thought of as “products” or “articles of manufacture” typically in the form of executable code and/or associated data that is carried on or embodied in a type of machine-readable medium. Tangible, non-transitory “storage” type media include any or all of the memory or other storage for the computers, processors or the like, or associated modules thereof, such as various semiconductor memories, tape drives, disk drives, solid state memory and the like, which may provide storage at any time for the software programming.

All or portions of the software may at times be communicated through a network such as the Internet or various other telecommunication networks. Such communications, for example, may enable loading of the software from one computer or processor into another, for example, from a server or host computer on the Internet into the hardware platform(s) of a computing environment or other system implementing a computing environment or similar functionalities in connection with the patent prosecution preparation unit 200. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium, or physical transmission medium. Non-volatile storage media include, for example, optical disks, solid state memory or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables, copper wire, and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media, therefore, include, for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the present teachings are amenable to a variety of modifications and/or enhancements. For example, although the implementation of various components described above may be embodied in a hardware device, it can also be implemented as a software-only solution—e.g., an installation on an existing server. In addition, systems and their components as disclosed herein can be implemented as a firmware, firmware/software combination, firmware/hardware combination, or a hardware/firmware/software combination.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

What is claimed is:

1. A method for editing patent claims performed by a machine including at least one processor, the method comprising:
receiving from a user, by the machine, first editing instructions for editing words of patent claims;
editing, by the machine, the words of the patent claims based on the first editing instructions to form words of amended patent claims; and
processing, by the machine, the words of the amended patent claims to form text for the amended patent claims, wherein
at least one instruction of the first editing instructions is transformed, by the machine, to form one or more second editing instructions, the one or more second editing instructions in compliance with editing requirements of a patent office and based on a current state of the words of the amended patent claims, and
the one or more second editing instructions are applied to the current state of the words of the amended patent claims.

2. The method according to claim 1, further comprising:
receiving, by the machine, text corresponding to the patent claims; and
separating, by the machine, the text into the words of the patent claims.

3. The method according to claim 1, wherein the one or more second editing instructions is based on whether a word to be edited by the at least one instruction in the current state of the words of the amended patent claims has already been submitted to the patent office.

4. The method according to claim 1, wherein
the one or more second editing instructions is based on whether a claim status of a claim of the amended patent claims edited by the at least one instruction is changed by the at least one instruction, and
the one or more second editing instructions includes an edit to a claim status identifier of the claim edited by the at least one instruction if the claim status is changed.

5. The method according to claim 1, wherein the one or more second editing instructions is based on whether a word to be edited is at least one of a punctuation character or a format character.

6. The method according to claim 1, further comprising:
receiving, by the machine, information regarding an office action for the patent claims; and
constructing, by the machine, text for a response to the office action based on the words of the amended patent claims and the information regarding the office action.

7. The method according to claim 6, further comprising:
constructing, by the machine, text for a letter to an applicant for the patent based on the words of the amended patent claims and the information regarding the office action.

8. A tangible non-transient computer readable medium comprising a set of instructions that causes a machine to perform a method for editing patent claims, the method comprising the steps of:
receiving, by the machine, text corresponding to patent claims;
separating, by the machine, the text into words of the patent claims;
receiving from a user, by the machine, first editing instructions for editing the words of the patent claims;
editing, by the machine, the words and the patent claims based on the editing instructions to form words of amended patent claims; and
processing, by the machine, the words of the amended patent claims to form text for amended patent claims, wherein
at least one instruction of the first editing instruction is transformed, by the machine, to form one or more second editing instructions, the one or more second editing instructions in compliance with the editing requirements of a patent office and based on a current state of the words of the amended patent claims, and
the one or more second editing instructions are applied to the current state of the words of the amended patent claims.

9. The tangible non-transient computer readable medium according to claim 8, wherein the one or more second editing instructions is based on whether a word to be edited by the first editing instruction in the current state of the words of the amended patent claims has already been submitted to the patent office.

10. The tangible non-transient computer readable medium according to claim 8, wherein
the one or more second editing instructions is based on whether a claim status of a claim of the amended patent claims edited by the at least one instruction is changed by the at least one instruction, and
the one or more second editing instructions includes an edit to a claim status identifier of the claim edited by the at least one instruction if the claim status is changed.

11. The tangible non-transient computer readable medium according to claim 8, wherein the one or more second editing instructions are based on whether a word to be edited is at least one of a punctuation character or a format character.

12. The tangible non-transient computer readable medium according to claim 8, the method further comprising:
receiving, by the machine, information regarding an office action for the patent claims; and
constructing, by the machine, text for a response to the office action based on the words of the amended patent claims and the information regarding the office action.

13. The tangible non-transient computer readable medium according to claim 12, the method further comprising:
constructing, by the machine, text for a letter to an applicant for the patent based on the words of the amended patent claims and the information regarding the office action.

14. An apparatus for editing patent claims comprising:
a first user interface adapted to receive input of first editing instructions for editing words of patent claims;
a claim editor unit adapted to edit the words of the patent claims based on the editing instructions to form words of amended patent claims; and
a claim display unit adapted to convert the words of the amended patent claims to form text for amended patent claims;
the claim editor unit comprising:
a claim editor logic unit adapted to transform at least one instruction of the first editing instructions to form one or more second editing instructions, the claim editor logic unit adapted to form the one or more second editing instructions in compliance with editing requirements of a patent office and based on a current state of the words of the amended patent claims, and the claim editor logic unit adapted to apply the one or more second editing instructions to the current state of the words of the amended patent claims.

15. The apparatus according to claim 14, further comprising:
a claim set analysis unit adapted to receive a text corresponding the patent claims and adapted to separate the text into the words of the patent claims.

16. The apparatus according to claim 14, wherein the one or more second editing instructions is based on whether a word to be edited in the current state of the words of the amended patent claims has already been submitted to the patent office.

17. The apparatus according to claim 14, wherein
the one or more second editing instructions is based on whether a claim status of a claim of the amended patent claims edited by the at least one instruction is changed by the at least one instruction, and
the one or more second editing instructions includes an edit to a claim status identifier of the claim edited by the first editing instruction if the claim status is changed.

18. The apparatus according to claim 14, wherein the one or more second editing instructions is based on whether a word to be edited in the current state of the words of the amended patent claims is at least one of a punctuation character or a format character.

19. The apparatus according to claim 14, further comprising:
a second user interface adapted to receive information regarding an office action from the patent office for the patent claims; and
a response construction unit adapted to construct a text for a response to the office action based on the words of the patent claims and the information regarding the office action.

20. The apparatus according to claim 19, further comprising:
a letter construction unit adapted to construct text for a letter to an applicant for the patent based on the words of the amended patent claims and the information regarding the office action.
